(19) United States
(12) Patent Application Publication
(10) Pub. No.: US 2025/0111671 A1
(43) Pub. Date: Apr. 3, 2025

(54) MEDIA ITEM CHARACTERIZATION BASED ON MULTIMODAL EMBEDDINGS

(71) Applicant: Google LLC, Mountain View, CA (US)

(72) Inventors: Tao Zhu, Los Altos, CA (US); Jiahui Yu, Bellevue, WA (US); Jingchen Feng, Los Altos, CA (US); Kai Chen, Brisbane, CA (US); Pooya Abolghasemi, Redwood Cty, CA (US); Gagan Bansal, Sunnyvale, CA (US); Jieren Xu, San Jose, CA (US); Hui Miao, Palo Alto, CA (US); Yaping Zhang, Mountain View, CA (US); Shuchao Bi, Mountain View, CA (US); Yonghui Wu, Palo Alto, CA (US); Claire Cui, Mountain View, CA (US); Rohan Anil, Lafayette, CA (US)

(21) Appl. No.: 18/900,457

(22) Filed: Sep. 27, 2024

Related U.S. Application Data
(60) Provisional application No. 63/587,047, filed on Sep. 29, 2023.
(60) Provisional application No. 63/587,046, filed on Sep. 29, 2023.

(51) Int. Cl. G06V 20/40; G06F 40/284; G10L 25/57

(52) U.S. Cl. CPC G06V 20/41; G06F 40/284; G06V 20/46; G10L 25/57

(57) ABSTRACT

Methods and systems for media item characterization based on multimodal embeddings are provided herein. A media item including a sequence of video frames is identified. A set of video embeddings representing visual features of the sequence of video frames is obtained. A set of audio embeddings representing audio features of the sequence of video frames is obtained. A set of audiovisual embeddings is generated based on the set of video embeddings and the set of audio embeddings. Each of the set of audiovisual embeddings represents a visual feature and an audio feature of a respective video frame of the sequence of video frames. One or more media characteristics associated with the media item are determined based on the set of audiovisual embeddings.

### RELATED APPLICATIONS

This non-provisional application claims priority to U.S. Provisional Patent Application No. 63/587,046, filed Sep. 29, 2023, entitled “Systems and Methods for Learning a Multimodal Embedding for Short-Term Videos,” and U.S. Provisional Patent Application No. 63/587,047, filed Sep. 29, 2023, entitled “Fine Grained Media Trend Representation and Detection Algorithms,” each of which are incorporated herein by reference in its entirety for all purposes.

### TECHNICAL FIELD

Aspects and implementations of the present disclosure relate to media item characterization based on multimodal embeddings.

### BACKGROUND

A platform (e.g., a content sharing platform, etc.) can enable to users share content with other users of the platform. For example, a user of the platform can provide a media item (e.g., a video item, etc.) to the platform to be accessible by other users of the platform. The platform can include the media item in a media item corpus of which the platform selects media items for sharing with users based on user interest. In some instances, one or more media items can be associated with a media trend. Media items associated with a media trend share a common concept or format that inspire the media item to be widely shared between users across the platform. In other instances, a media item can be associated with one or more other media characteristics. Detecting a media trend, identifying media items that are associated with the media trend, and determining other media characteristics of a media item can be time consuming and/or resource intensive for the platform.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes identifying a media item including a sequence of video frames. The method further includes obtaining a set of video embeddings representing visual features of the sequence of video frames. The method further includes obtaining a set of audio embeddings representing audio features of the sequence of video frames. The method further includes generating a set of audiovisual embeddings based on the set of video embeddings and the set of audio embeddings. Each of the set of audiovisual embeddings represents a visual feature and an audio feature of a respective video frame of the sequence of video frames. The method further includes determining one or more media characteristics associated with the media item based on the set of audiovisual embeddings.

In some implementations, obtaining the set of video embeddings includes providing each of the sequence of video frames as an input to an image encoder. The method further includes obtaining, based on one or more outputs of the image encoder, a sequence of image tokens each representing one or more visual features of a respective video frame of the sequence of video frames. The set of video embeddings includes the sequence of image tokens.

In some implementations, the image encoder includes a vision transformer.

In some implementations, the one or more visual features include at least one of: a scene depicted by the sequence of video frames, an object of the scene depicted by the sequence of video frames, at least one of an action, a motion, or a pose of the object of the scene, one or more colors included in the scene, or one or more lighting features associated with the scene.

In some implementations, obtaining the set of audio embeddings includes extracting, from the media item, an audio signal associated with a respective video frame of the sequence of video frames. The method further includes providing the extracted audio signal as an input to an audio encoder. The method further includes obtaining, based on one or more outputs of the audio encoder, an audio embedding representing audio features of the audio signal.

In some implementations, the audio encoder includes an audio spectrogram transformer.

In some implementations, the one or more audio features include at least one of a pitch of an audio signal of the media item, a timbre of the audio signal, a rhythm of the audio signal, speech content of the audio signal, speaker characteristics associated with the audio signal, environmental sounds associated with a scene of the media item, spectral features of the audio signal, or temporal dynamics of the audio signal.

In some implementations, the method further includes obtaining a set of textual embeddings representing textual features associated with content of the sequence of video frames. The one or more media characteristics associated with the media items are further determined based on the set of textual embeddings.

In some implementations, obtaining the set of textual embeddings includes providing the textual features associated with content of the sequence of video frames as an input to a text encoder. The method further includes obtaining, based on one or more outputs of the text encoder, one or more text tokens representing the textual features. The set of textual embeddings includes the one or more text tokens.

In some implementations, the text encoder comprises a bidirectional encoder representations from transformers (BERT) encoder.

In some implementations, generating the set of audiovisual embeddings includes performing one or more concatenation operations to concatenate a video embedding of the set of video embeddings with an audio embedding of the set of audio embeddings.

In some implementations, the method further includes obtaining an output of the one or more concatenation operations. The method further includes performing one or more attention pooling operations to the obtained output of the one or more concatenation operations. The one or more attention pooling operations includes an audiovisual embedding. The method further includes updating the set of audiovisual embeddings to include the audiovisual embedding.

In some implementations, the one or more media characteristics include at least one of whether the media item is associated with a media trend of a platform, a degree of interest in content of the media item by one or more users of the platform, or at least one of an image quality or an audio quality of the media item.

In some implementations, the visual features of the sequence of video frames include one or more poses of an object depicted by the sequence of video frames. Determining one or more media characteristics associated with the media item includes identifying a set of embeddings for an additional media item associated with a media trend. The set of embeddings represent visual features of one or more poses of an additional object depicted by an additional sequence of video frames of the additional media item. The method further includes determining whether a degree alignment between the one or more poses of the object and the one or more poses of the additional object satisfy one or more alignment criteria based on the set of audiovisual embeddings for the media item and the set of embeddings for the additional media item. The method further includes, responsive to determining that the degree of alignment satisfies the one or more alignment criteria, determining that the media item is associated with the media trend.

In some implementations, the method further includes providing the set of audiovisual embeddings for the media item and the set of embeddings for the additional media item as an input to one or more comparison operations. The method further includes obtaining, based on one or more outputs of the one or more comparison operations, the degree of alignment between the respective pose of the object and the one or more poses of the additional media item. The degree of alignment represents a difference between the visual features of the one or more embeddings for the media item and the set of embeddings for the additional media item.

In some implementations, the one or more comparison operations include a dynamic time warping function.

In some implementations, determining whether the degree of alignment satisfies the one or more alignment criteria includes determining whether the difference between the visual features of the set of audiovisual embeddings for the media item and the set of embeddings for the additional media item falls below a difference threshold.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example platform, an example media item manager, and an example trend engine, in accordance with implementations of the present disclosure.

FIG. 3 is a block diagram of an example trend engine, in accordance with implementations of the present disclosure.

FIG. 4 is a block diagram of an example method for media trend detection of content sharing platforms, in accordance with implementations of the present disclosure.

FIG. 5 illustrates an example of generating an embedding for media trend detection of content sharing platforms, in accordance with implementations of the present disclosure.

FIG. 6 is a block diagram of an illustrative predictive system, in accordance with implementations of the present disclosure.

FIG. 7 is a block diagram of an example method for media item characterization, in accordance with implementations of the present disclosure.

FIG. 8 depicts an example of comparing media item embeddings for media item characterization, in accordance with implementations of the present disclosure.

FIG. 9 is a block diagram illustrating an exemplary computer system, in accordance with implementations of the present disclosure.

### DETAILED DESCRIPTION OF THE DRAWINGS

Aspects of the present disclosure generally relate to media item characterization based on multimodal embeddings. A platform (e.g., a content sharing platform) can enable users to share media items (e.g., video items, audio items, etc.) with other users of the platform. Some media items can include and/or share particular media item characteristics. For example, some media items can be part of or otherwise associated with a media trend. A media trend refers to a phenomenon in which a set of media items share a common format or concept and, in some instances, are distributed widely among users of a platform. Media items that are associated with a media trend may share common visual features (e.g., dance moves, poses, actions, etc.), common audio features (e.g., songs, sound bites, etc.), common metadata (e.g., hashtags, titles, etc.), and so forth. One example of a media trend can include a dance challenge trend, where associated media items depict users performing the same or a similar dance moves to a common audio signal. It can be useful for a system to identify media items that share common media item characteristics, as such identified media items can be used to determine and/or predict an overall quality and/or classification of videos included in a video corpus.

Users may provide (e.g., upload) a significantly large number of media items to the platform each day (e.g., hundreds of thousands, millions, etc.). Given such large number of uploaded media items, it can be challenging for the platform to perform media characterization tasks, such as detecting media trends among such media items and/or previously uploaded media items. For instance, on a given day, multiple users may upload media items to the platform that share a common format or concept. Users of a platform may want to be informed of new media trends that emerge at a platform and/or which media items of the platform are part of the media trend (e.g., so the users can participate in the media trend by uploading a media item sharing the common format or concept of the media trend). It can be difficult for a platform to identify, of the large number of media items uploaded by users each day, whether a new media trend has emerged and/or which media items are associated with the media trend. It can further be difficult for systems to perform other types of media characterization tasks, including but not limited to video quality prediction and/or video classification, given the large number of uploaded media items.

Some conventional systems perform media item characterization for uploaded media items based on audiovisual features of the media items and/or user-provided metadata. For instance, a conventional platform may detect that a significant number of media items uploaded within a particular time period share a common audio signal (e.g., a common song). The conventional platform may determine whether metadata (e.g., titles, captions, hashtags, etc.) provided by users associated with such media items share common features (e.g., common words in the title or caption, common hashtags, etc.) and, if so, may determine that such media items are associated with a media trend. In an illustrative example, the platform may determine that media items including the song titled “I love to dance” are each associated with the common hashtag “#lovetodancechallenge.” Therefore, the conventional platform may detect that a media trend has emerged and such media items are associated with the detected media trend. Upon detecting the media trend, the conventional platform may associate each newly uploaded media item having the common song and/or associated with the hashtag with the media trend and, in some instances, may provide a notification to users accessing such media items.

As indicated above, users can upload a significantly large number of media items to a platform each day. It can take a significant amount of computing resources (e.g., processing cycles, memory space, etc.) to identify media items sharing common audiovisual features and determine, based on the user-provided metadata, whether such media items share common media item characteristics (e.g., are associated with a new or existing media trend). In some instances, a large portion of uploaded media items can share common audiovisual features and may share some common metadata features, but in fact may not actually share common media item characteristics (e.g., may not be related to the same media trend). By basing media item characterization on common user-provided metadata, a conventional platform may not be able to accurately determine characteristics of media items uploaded to a platform, such as detecting whether a set of media items are part of the same media trend or whether the media items, although having some commonalities, are not part of the same media trend. Further, the overall characteristics of media items in a corpus can evolve multiple times during a time period (e.g., based on the characteristics of the media items being provided to the platform). Accordingly, media items of a media trend that are uploaded earlier in the time period may have different user-provided metadata than media items of the media trend that are uploaded later in the time period (e.g., due to the evolution of a media trend during the time period). Therefore, conventional platforms may be unable to accurately detect that such earlier uploaded media items and/or later uploaded media items share common media item characteristics (e.g., are part of the same media trend). In some instances, the system therefore is unable to accurately notify users of the media trend and/or which media items are part of the media trend and therefore the computing resources consumed to identify the media trend are wasted. Further, a user that wishes to participate in a media trend and/or find media items having particular characteristics may spend additional time searching through media items of the platform, which may consume further computing resources. Such computing resources are therefore unavailable to other processes of the system, which increases an overall latency and decreases an overall efficiency of the system.

Implementations of the present disclosure address the above and other deficiencies by providing methods and systems for media item characterization based on multimodal embeddings. A system can identify a media item including a sequence of video frames. The media item can be identified from a media item data store of a platform (e.g., a content sharing platform) or can be received from a client device associated with a user of the platform. The system can obtain a set of video embeddings representing visual features of the sequence of video frames. A video embedding refers to a representation of video features of a media item in a low-dimensional vector space. The visual features represented by the video embeddings can include, for example, spatial features (e.g., detected objects, people or scenery, shapes, colors, textures, etc.), temporal features (e.g., how the objects move or change over time), scene context features (e.g., an environment of a scene, background information of the video content), and so forth. The system can obtain the set of video embeddings based on one or more outputs of a video encoder (e.g., a vision transformer), in some embodiments. The system can also obtain a set of audio embeddings representing audio features of the sequence of video frames. An audio embedding refers to a representation of an audio signal of a media item in a low-dimensional space. Audio features of a media item can include, for example, pitch, timbre, rhythm, speech content (e.g., phonemes, syllables, word, etc.), speaker characteristics, environmental sounds, spectral features (e.g., frequency content), temporal dynamics (e.g., how sound evolves overtime), and so forth. The system can obtain the set of audio embeddings based on one or more outputs of an audio encoder (e.g., an audio spectrogram transformer, etc.), in some embodiments.

The system can generate a set of audiovisual embeddings for the sequence of video frames based on the set of video embeddings. Each of the set of audiovisual embeddings can represent a visual feature and an audio feature of a respective video frame of the sequence of video frames. In some embodiments, the system can generate the set of audiovisual embeddings by concatenating each video embedding for a respective video frame to a corresponding audio embedding for the respective video frame. The system can provide the concatenated embeddings as an input to one or more attention pooling operations (e.g., operations that reduce a dimensionality of a feature map) and can extract each of the set of audiovisual embeddings from one or more outputs of the attention pooling operations.

In some embodiments, the system can obtain a set of textual embeddings representing textual features of content of the media item. The system can obtain the set of textual embeddings by providing textual data associated with the media item (e.g., a title of the media item, a description of the media item, a keyword of the media item, a transcript of the media item, etc.) as an input to a text encoder (e.g., a bidirectional encoder representations from transformers (BERT) encoder) and obtaining one or more outputs of the text encoder.

The system can determine one or more media characteristics associated with the media item based on the set of audiovisual embeddings and the set of textual embeddings. The one or more media characteristics can include whether the media item is associated with a media trend of a platform, a degree of interest in content of the media item by one or more users of the platform, an image quality and/or an audio quality of the media item, and so forth. In some embodiments, the system can compare the audiovisual embeddings and/or textual embeddings obtained for a media item with embeddings for another media item associated with a media trend to determine whether the media item is also associated with the media trend. For example, the other media item may be associated with a dance challenge media trend. The audiovisual embeddings associated with the media item and the other media item can indicate visual features (e.g., poses) of objects depicted by the media items. The system can determine whether a degree of alignment between one or more visual features of an object depicted by the media item and one or more visual features of an additional object depicted by the additional media item satisfy one or more alignment criteria based on the audiovisual embeddings obtained for the media items. Upon determining that the alignment criteria are satisfied, the system can determine that the media item is associated with the media trend. The system can use the audiovisual embeddings and/or the textual embeddings obtained for media items to detect newly emerging media trends at a media platform, in accordance with embodiments described herein.

Aspects of the present disclosure provide AI-based techniques for media item characterization based on audiovisual embeddings and/or textual embeddings of the media items. As described above, the system generates audiovisual embeddings and textual embeddings representing the audiovisual and textual features of a media item, which can be used to perform a variety of media characterization tasks, including media trend detection. Using the audiovisual and textual embeddings, the system is able to more accurately characterize media items at a platform, which can enable the platform to detect media trends, determine a degree of interest in content of a media item, determine an image quality and/or an audio quality of a media item, etc. more accurately and efficiently. Thus, the system is able to provide users with media items of interest and/or of higher quality, and the system consumes fewer resources providing users with media items they are not interested in and/or of lower quality. Further, as the audiovisual embeddings and textual embeddings generated by the system can be used for different media characterization tasks, the system does not consume excess resources performing such tasks based on individual data sets, which can decrease an overall amount of memory space and processing cycles consumed by the system. Such computing resources are made available to other processes, which further improves the latency and efficiency of the overall system.

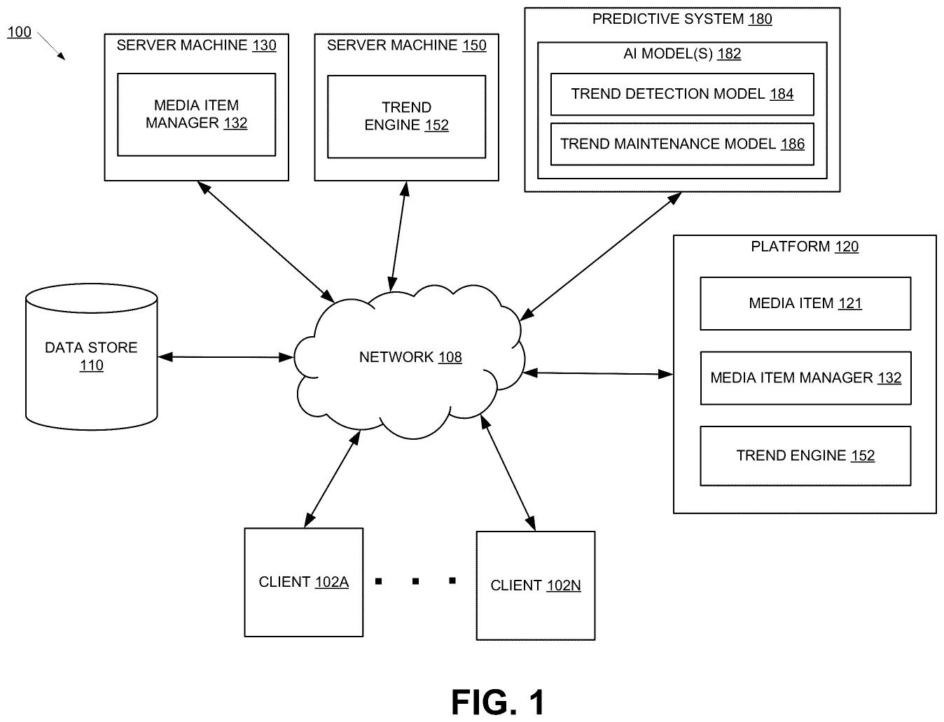

FIG. 1 illustrates an example system architecture 100, in accordance with implementations of the present disclosure. The system architecture 100 (also referred to as “system” herein) includes client devices 102A-N, a data store 110, a platform 120, and/or one or more server machines (e.g., server machine 130, server machine 150, etc.) each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more portions of a document and/or a file displayed via a graphical user interface (GUI) on a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 108.

The client devices 102A-N (collectively and individually referred to as client device(s) 102 herein) can each include computing devices such as personal computers (PCs), laptops, mobile phones, smart phones, tablet computers, netbook computers, network-connected televisions, etc. In some implementations, client devices 102A-N may also be referred to as “user devices.” Client devices 102A-N can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers may be embedded media players that are embedded in web pages provided by the platform 120.

A media item 121 can be consumed via the Internet or via a mobile device application, such as a content viewer of client devices 102A-N. In some embodiments, a media item 121 can correspond to a media file (e.g., a video file, an audio file, a video stream, an audio stream, etc.). In other or similar embodiments, a media item 121 can correspond to a portion of a media file (e.g., a portion or a chunk of a video file, an audio file, etc.). As discussed previously, a media item 121 can be requested for presentation to the user by the user of the platform 120. As used herein, “media,” media item,” “online media item,” “digital media,” “digital media item,” “content,” and “content item” can include an electronic file that can be executed or loaded using software, firmware or hardware configured to present the digital media item to an entity. As indicated above, the platform 120 can store the media items 121, or references to the media items 121, using the data store 110, in at least one implementation. In another implementation, the platform 120 can store media item 121 or fingerprints as electronic files in one or more formats using data store 110. Platform 120 can provide media item 121 to a user associated with a client device 102A-N by allowing access to media item 121 (e.g., via a content platform application), transmitting the media item 121 to the client device 102, and/or presenting or permitting presentation of the media item 121 via client device 102.

In some embodiments, media item 121 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some embodiments, a video item can be stored (e.g., at data store 110) as a video file that includes a video component and an audio component. The video component can include video data that corresponds to one or more sequential video frames of the video item. The audio component can include audio data that corresponds to the video data.

In some embodiments, a media item 121 can be a short-form media item. A short-form media item refers to a media item 121 that has a duration that falls below a particular threshold duration (e.g., as defined by a developer or administrator of platform 120). In one example, a short-form media item can have a duration of 120 seconds or less. In another example, a short-form media item can have a duration of 60 seconds or less. In other or similar embodiments, a media item 121 can be a long-form media item. A long-form media item refers to a media item that has a longer duration than a short-form media item (e.g., several minutes, several hours, etc.). In some embodiments, a short-form media item may include visually or audibly rich or complex content for all or most of the media item duration, as a content creator has a smaller amount of time to capture the attention of users accessing the media item 121 and/or to convey a target message associated with the media item 121. In additional or similar embodiments, a long-form media item may also include visually or audibly rich or complex content, but such content may be distributed throughout the duration of the long-form media item, diluting the concentration of such content for the duration of the media item 121. As described above, data store 110 can store media items 121, which can include short-form media items and/or long-form media items, in some embodiments. In additional or alternative embodiments, data store 110 can store one or more long-form media items and can store an indication of one or more segments of the long-form media items that can be presented as short-form media items. It should be noted that although some embodiments of the present disclosure refer specifically to short-form media items, such embodiments can be applied to long-form media items, and vice versa. It should also be noted that embodiments of the present disclosure can additionally or alternatively be applied to live streamed media items (e.g., which may or may not be stored at data store 110).

Platform 120 can include multiple channels (e.g., channels A through Z). A channel can include one or more media items 121 available from a common source or media items 121 having a common topic, theme, or substance. Media item 121 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “liking,” “following,” “friending,” and so on.

In some embodiments, system 100 can include one or more third party platforms (not shown). In some embodiments, a third party platform can provide other services associated media items 121. For example, a third party platform can include an advertisement platform that can provide video and/or audio advertisements. In another example, a third party platform can be a video streaming service provider that produces a media streaming service via a communication application for users to play videos, TV shows, video clips, audio, audio clips, and movies, on client devices 102 via the third party platform.

Platform 120 can include a media item manager 132 that is configured to manage media items 121 and/or access to media items 121 of platform 120. As described above, users of platform 120 can provide media items 121 (e.g., long-form media items, short-form media items, etc.) to platform 120 for access by other users of platform 120. As described herein, a user that creates or otherwise provides a media item 121 for access by other users is referred to as a “creator.” A creator can include an individual user and/or an enterprise user that creates content for or otherwise provides a media item 121 to platform 120. A user that accesses a media item 121 is referred to as a “viewer,” in some instances. The user can provide (e.g., upload) the media item 121 to platform 120 via a user interface (UI) of a client device 102, in some embodiments. Upon providing the media item 121, media item manager 132 can store the media item 121 at data store 110 (e.g., at a media item corpus or repository of data store 110).

In some embodiments, media item manager 132 can store the media item 121 with data or metadata associated with the media item 121. Data or metadata associated with a media item 121 can include, but is not limited to, information pertaining to a duration of media item 121, information pertaining to one or more characteristics of media item 121 (e.g., a type of content of media item 121, a title or a caption associated with the media item, one or more hashtags associated with the media item 121, etc.), information pertaining to one or more characteristics of a device (or components of a device) that generated content of media item 121, information pertaining to a viewer engagement pertaining to the media item 121 (e.g., a number of viewers who have endorsed the media item 121, comments provided by viewers of the media item, etc.), information pertaining to audio of the media item 121 and/or associated with the media item 121, and so forth. In some embodiments, media item manager 132 can determine the data or metadata associated with the media item 121 (e.g., based on media item analysis processes performed for a media item received by platform 120). In other or similar embodiments, a user (e.g., a creator, a viewer, etc.) can provide the data or metadata for the media item 121 (e.g., via a UI of a client device 102). In an illustrative example, a creator of the media item 121 can provide a title, a caption, and/or one or more hashtags pertaining to the media item 121 with the media item 121 to platform 120. The creator can additionally or alternatively provide tags or labels associated with the media item 121, in some embodiments. Upon receiving the data or metadata from the creator (e.g., via network 104), media item manager 132 can store the data or metadata with media item 121 at data store 110.

As used herein, a hashtag refers to a metadata tag that is prefaced by the hash symbol (e.g., “#”). A hashtag can include a word or a phrase that is used to categorize content of the media item 121. As indicated above, in some embodiments, a creator or user associated with a media item 121 can provide platform 120 with one or more hashtags for the media item 121. In other or similar embodiments, media item manager 132 and/or another component of platform 120 or of another computing device of system 100 can derive or otherwise obtain a hashtag for media item 121. It should be noted that the term “hashtag” is used throughout the description for purposes of example and illustration only. Embodiments of the present disclosure can be applied to any type of metadata tag, regardless of whether such metadata tag is prefaced by the hash symbol.

In some embodiments, a client device 102 can transmit a request to platform 120 for access to a media item 121. Platform 120 may identify the media item 121 of the request (e.g., at data store 110, etc.) and may provide access to the media item 121 via the UI of the content viewer provided by platform 120. In some embodiments, the requested media item 121 may have been generated by another client device 102 connected to platform 120. For example, client device 102A can generate a video item (e.g., via an audiovisual component, such as a camera, of client device 102A) and provide the generated video item to platform 120 (e.g., via network 108) to be accessible by other users of the platform. In other or similar embodiments, the requested media item 121 may have been generated using another device (e.g., that is separate or distinct from client device 102A) and transmitted to client device 102A (e.g., via a network, via a bus, etc.). Client device 102A can provide the video item to platform 120 (e.g., via network 108) to be accessible by other users of the platform, as described above. Another client device, such as client device 102N, can transmit the request to platform 120 (e.g., via network 108) to access the video item provided by client device 102A, in accordance with the previously provided examples.

Trend engine 152 can detect one or more media trends among media items 121 of platform 120 and/or can determine whether a respective media item 121 is associated with a media trend. A media trend refers to a phenomenon in which content of a set of media items share a common format or concept and, in some instances, are shared widely among users of platform 120. Media items that are associated with a media trend may share common visual features (e.g., dance moves, poses, actions, etc.), common audio features (e.g., songs, sound bites, etc.), common metadata (e.g., titles, captions, hashtags, etc.), and so forth. In some instances, a creator can upload to platform 120 (e.g., via a UI of a client device 102) a media item 121 including content having a particular format or concept for sharing with other users of platform 120. One or more other users of platform 120 can access the creator's media item 121 and, in some instances, may be inspired to create their own media items 121 that share the particular format or concept of the accessed media item 121. In some instances, a significantly large number of users (e.g., hundreds, thousands, millions, etc.) can create media items 121 sharing the particular format or concept of the original creator's media item 121. In accordance with embodiments described herein, trend engine 152 may detect such media items 121 sharing the particular format or concept as a media trend. Examples of media trends can include, but are not limited to, dance trends or dance challenge trends, memes or pop culture trends, branded hashtag challenge trends, and so forth. For purposes of example and illustration only, some embodiments and examples herein are described with respect to a dance trend or a dance challenge trend. It should be noted that such embodiments and examples are not intended to be limiting and embodiments of the present disclosure can be applied to any kind of media trend for any type of media item (e.g., a video item, an audio item, an image item, etc.).

As described herein, trend engine 152 may detect a media trend that originated based on a media item 121 provided by a particular creator (or group of creators). Such media item 121 is referred to herein as a “seed” media item 121. In some instances, the common format or concept shared by media items 121 of a trend may deviate from the original format or concept of the seed media item 121 that initiated the trend. In some embodiments, trend engine 152 may identify a media item 121 (or a set of media items) associated with the media trend of which the common format or concept is determined to initiate the deviation from the original format or concept of the seed media item 121. In some embodiments, such identified media item 121 may be designated as the seed media item 121 for the media trend. In other or similar embodiments, the original media item 121 and the identified media item 121 may both be designated as seed media items 121 for the media trend.

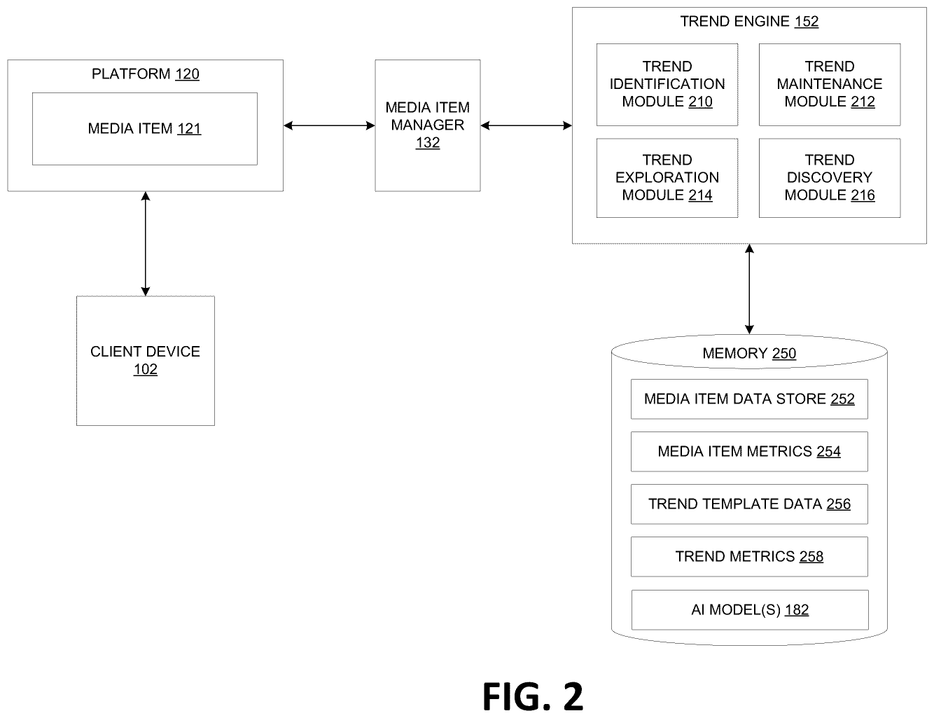

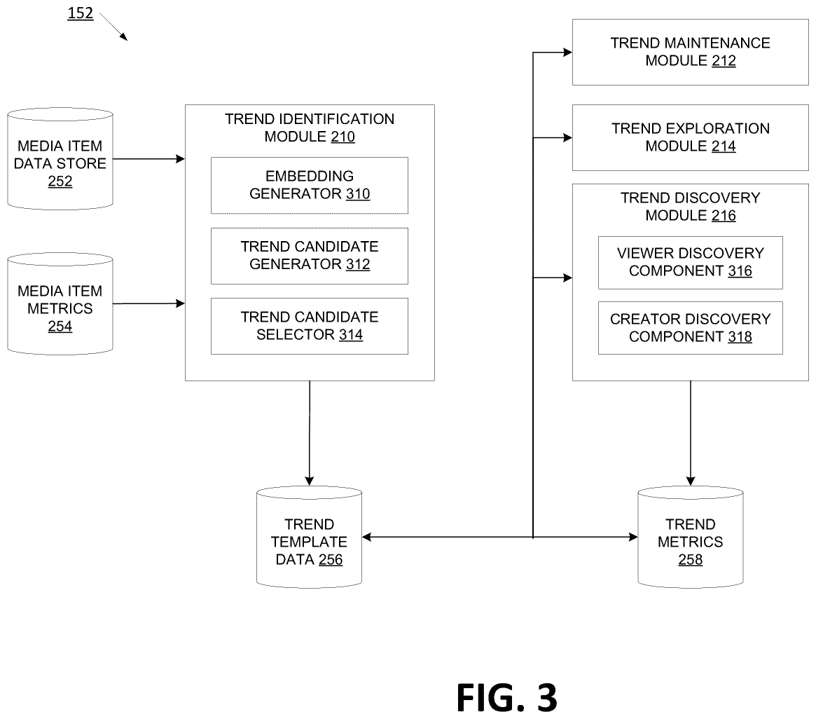

In some embodiments, trend engine 152 may determine one or more features (e.g., video features, audio features, textual features, etc.) of media items 121 of a media trend that are specific or unique to the format or concept of the media trend. Such features may define a template for the media trend for which other media items 121 replicating the media trend are to include. As described herein, trend engine 152 can determine such features and can store data indicating such features as trend template data (e.g., trend template data 256 of FIGS. 2 and 3). Trend engine 152 can determine whether subsequently uploaded media items 121 are part of a media trend by comparing features of the uploaded media items 121 to features indicated by the trend template data, in accordance with embodiments described herein. Further details regarding trend engine 152 and detecting media trends are provided herein with respect to FIGS. 2-8.

As illustrated in FIG. 1, system 100 can also include a predictive system 180, in some embodiments. Predictive system 180 can implement one or more artificial intelligence (AI) and/or machine learning (ML) techniques for performing tasks associated with media trend detection. In some embodiments, predictive system 180 can train one or more AI models 182 (e.g., a machine learning model) to detect whether a new media trend has emerged with respect to media items 121 uploaded to platform 120 and/or whether a media item 121 uploaded to platform 120 is part of a detected media trend. For purposes of explanation and example only, an AI model 182 that is trained to detect an emerging media trend is referred to as a trend detection model 184 and an AI model 182 trained to determine whether a media item 121 uploaded to platform 120 is part of a detected media trend is referred to as a trend maintenance model 186. It should be noted that while in some embodiments, functionalities of the trend detection model 184 may be separate from the functionalities of the trend maintenance model 186. However, in other or similar embodiments, functionalities of the trend detection model 184 and the trend maintenance model 186 can be performed by the same AI model 182. Further details regarding inference and training of the AI models are provided below.

It should be noted that although FIG. 1 illustrates trend engine 152 as part of platform 120, in additional or alternative embodiments, trend engine 152 can reside on one or more server machines or systems that are remote from platform 120 (e.g., server machine 130, server machine 150, predictive system 180). It should be noted that in some other implementations, the functions of server machines 130, 150, predictive system 180 and/or platform 120 can be provided by a fewer number of machines. For example, in some implementations, components and/or modules of any of server machines 130, 150 and/or predictive system 180 may be integrated into a single machine, while in other implementations components and/or modules of any of server machines 130, 150 and/or predictive system 180 may be integrated into multiple machines. In addition, in some implementations, components and/or modules of any of server machines 130, 150 and/or predictive system 180 may be integrated into platform 120.

In general, functions described in implementations as being performed by platform 120 and/or any of server machines 130, 150 and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing an electronic document, implementations can also be generally applied to any type of documents or files. Implementations of the disclosure are not limited to electronic document platforms that provide document creation, editing, and/or viewing tools to users. Further, implementations of the disclosure are not limited to text objects or drawing objects and can be applied to other types of objects.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 is a block diagram of an example platform 120, an example media item manager 132, and an example trend engine 152, in accordance with implementations of the present disclosure. As described above, platform 120 can provide users (e.g., of client devices 102) with access to media items 121. Media items 121 can include long-form media items and/or short-form media items. In some embodiments, a user (e.g., a creator) can provide a media item 121 to platform 120 for access by other users (e.g., viewers) of platform 120. Media item manager 132 can identify media items 121 of interest and/or relevant to users (e.g., based on a user access history, a user search request, etc.) and can provide the users with access to the identified media items 121 via client devices 102. As described herein, trend engine 152 can detect when a new media trend has emerged among media items 121 provided by users of platform 120 and/or can determine whether a particular media item 121 provided by a user is associated with an existing media trend of platform 120. Further, trend engine 152 can notify users accessing media items 121 of platform 120 of the detected media trends and which media items 121 are a part of such detected media trends.

As illustrated in FIG. 2, trend engine 152 can include a trend identification module 210, a trend maintenance module 212, a trend exploration module 214, and/or a trend discovery module 216. Trend identification module 210 can perform one or more operations associated with trend identification, which can include identification of one or more media items 121 that may initiate or otherwise correspond to an emerging media trend and/or determine trend template data for a detected media trend. Trend maintenance module 212 can perform one or more operations associated with trend maintenance, including detecting newly uploaded media items 121 that correspond to a detected media trend and, if needed, updating trend template data 256 for a detected trend based on an evolution of the media trend over time. Trend exploration module 214 can perform one or more operations associated with trend exploration, which can include determining a context and/or a purpose of the media trend and, in some embodiments, identifying features of media items 121 of the media trend of which particular audiences of users are particularly interested. Trend discovery module 216 can perform one or more operations associated with trend discovery, which can include surfacing media trends and/or media items 121 associated with particular media trends to users, alerting media item creators that their media item 121 has initiated or is part of a media trend, and/or providing creators with access to tools to enable the creators to control the use or distribution of their media item 121 in accordance with the media trend. It should be noted that trend engine 152 can include one or more additional or alternative modules, in some embodiments. It should also be noted that although some operations or functionalities are described with respect to particular modules of trend engine 152, any of trend identification module 210, trend maintenance module 212, trend exploration module 214, trend discovery module 216, and/or any alternative or additional modules of trend engine 152 can perform any operations pertaining to trend detection and surfacing, as described herein. Details regarding trend detection by trend engine 152 are provided below with respect to FIGS. 3-5.

In some embodiments, platform 120, media item manager 132, and/or trend engine 152, can be connected to memory 250 (e.g., via network 108, via a bus, etc.). Memory 250 can correspond to one or more regions of data store 110, in some embodiments. In other or similar embodiments, one or more portions of memory 250 can include or otherwise correspond any memory of or connected to system 100. Data, data items, data structures, and/or models stored at memory 250, as depicted by FIG. 2, are described in conjunction with FIGS. 3-6.

FIG. 3 is a block diagram of an example trend engine 152, in accordance with implementations of the present disclosure. Trend engine 152 can include or otherwise correspond to trend engine 152 of FIGS. 1-2. As described above, trend engine 152 can detect when a new media trend has emerged among media items 121 provided by users of platform 120 and/or can determine whether a particular media item 121 provided by a user is associated with an existing media trend of platform 120. Further, trend engine 152 can notify users accessing media items 121 of platform 120 of the detected media trends and which media items 121 are a part of such detected media trends.

Media items 121 evaluated by trend engine 152 can be stored at media item data store 252 of memory 250, in some embodiments. In an illustrative example, a user of a client device 102 can provide a media item 121 to platform 120 to be shared with other users of platform 120. Upon receiving the media item 121, media item manager 132 (or another component of platform 120) may store the media item 121 at media item data store 252. In some embodiments, media item data store 252 can additionally or alternatively store metadata associated with a media item 121 (e.g., a title of the media item 121, a description of the media item 121, etc.). Metadata for a media item 121 may be received by platform 120 with the media item 121 and/or may be determined by platform 120 (e.g., after receiving the media item 121). Trend engine 152 may evaluate a respective media item 121 for association with a media trend at any time after the media item 121 is received by platform 120. For example, upon receiving the media item 121, trend engine 152 may perform one or more operations described herein to determine whether the media item 121 is associated with a media trend (e.g., prior to or while users of platform 120 access media item 121). In another example, platform 120 may provide users with access to media item 121 and, after a period of time (e.g., hours, days, weeks, months, etc.), trend engine 152 may evaluate whether the media item 121 is associated with a media trend, as described herein.

As described above, trend identification module 210 can perform one or more operations associated with trend identification. Trend identification refers to the detection of media trends among media items 121 of platform 120 and/or determining whether a newly uploaded media item 121 corresponds to a previously detected media trend. In some embodiments, trend identification module 210 can include an embedding generator 310, a trend candidate generator 312, and/or a trend candidate selector 314. Embedding generator 310 can generate one or more embeddings representing features of a media item 121. An embedding refers to a representation of data (e.g., usually high-dimensional and complex) in a lower-dimensional vector space. Embeddings can transform complex data types (e.g., text, images, audio, etc.) into numerical vectors that can be processed and analyzed more efficiently by AI models or other such algorithms (e.g., AI model(s) 182). In some embodiments, embedding generator 310 can generate a set of audiovisual embeddings that represent audiovisual features of a media item 121. Embedding generator 310 can additionally or alternatively generate a set of textual embeddings that represent textual features of the media item 121. The set of audiovisual embeddings can represent one or more audiovisual features of the media item 121 and the set of textual embeddings can represent one or more textual features of the media item 121.

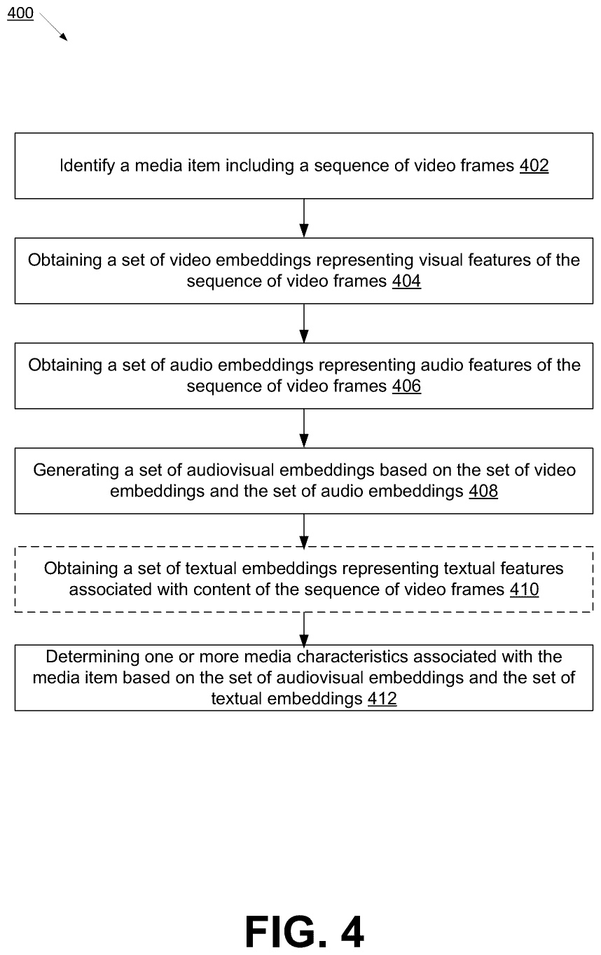

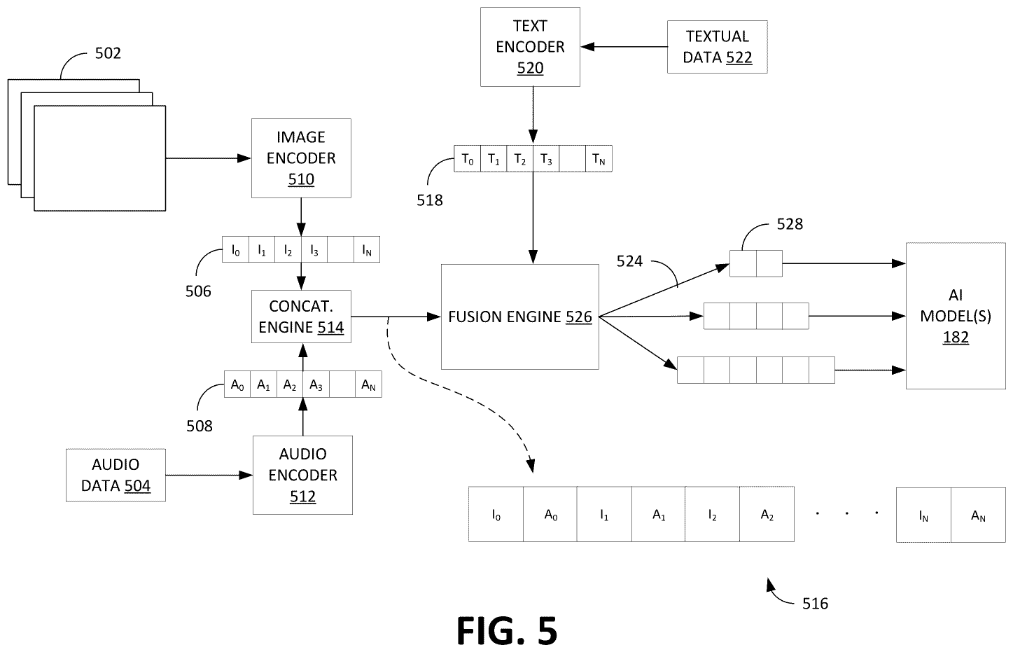

In some embodiments, embedding generator 310 can generate the set of audiovisual embeddings by obtaining video embeddings and audio embeddings for the media item 121 and performing one or more operations to fuse the video embeddings with the audio embeddings. The video embeddings can be obtained based on one or more outputs of an image encoder (e.g., a vision transformer, a convolutional neural network, etc.) and can represent video features of one or more frames of the media item 121, including spatial features (e.g., detected objects, people or scenery, shapes, colors, textures, etc.), temporal features (e.g., how the objects move or change over time), scene context features (e.g., an environment of a scene, background information of the video content), and so forth. The audio embeddings can be obtained based on one or more outputs of an audio encoder (e.g., an audio spectrogram transformer, etc.) and can represent audio features of the one or more frames, including pitch, timbre, rhythm, speech content (e.g., phonemes, syllables, word, etc.), speaker characteristics, environmental sounds, spectral features (e.g., frequency content), temporal dynamics (e.g., how sound evolves overtime), and so forth. Embedding generator 310 can generate the set of audiovisual embeddings by performing one or more concatenation operations with respect to the video embeddings and the audio embeddings and, in some embodiments, performing one or more attention pooling operations with respect to the concatenated video and audio embeddings. Embedding generator 310 can generate the set of textual embeddings for the media item 121 by providing textual data associated with the media item 121 (e.g., a title, a description, one or more keywords or hashtags, a transcript generated based on one or more audio signals associated with the media item 121, etc.) as an input to a text encoder (e.g., a bidirectional encoder representations from transformations (BERT) encoder, a robustly optimized BERT approach (ROBERTa) encoder, a generative pre-trained transformer (GPT) encoder, a text-to-text transfer transformer (T5) encoder, etc.). Further details regarding generating the audiovisual embeddings and/or the textual embeddings are provided herein with respect to FIGS. 4-5.

In some embodiments, embedding generator 310 can store the embeddings generated or otherwise obtained for a media item 121 at media item data store 252 (e.g., with metadata for the media item 121). In other or similar embodiments, embedding generator 310 can store the embeddings for a media item 121 at another region of memory 250 or at another memory of or accessible to components of system 100.

Trend candidate generator 312 can identify one or more media items 121 of media item data store 252 that are candidates for association with a media trend. In some embodiments, trend candidate generator 312 can provide audiovisual embeddings and textual embeddings generated for media items 121 of media item data store 252 as an input to one or more AI models 182. The AI model(s) 182 can include a trend detection model 184, which can be trained to perform one or more clustering operations to identify clusters or groups of media items 121 sharing common or similar video and/or audio features, in view of their embeddings. In some embodiments, the one or more clustering operations can include a k-means clustering operation, a hierarchical clustering operation, gaussian mixture model (GMM) operation, or any other such type of clustering operation. Trend candidate generator 312 can obtain one or more outputs of the trend detection model 184, which can indicate a distance between each of a set of media items 121 of an identified cluster or group. The distance indicated by the model outputs can indicate a distance between of the visual or audio features for each of the set of media items 121, in view of the textual features associated with such media items 121. Trend candidate generator 312 can determine that the set of media items 121 indicated by the output(s) of the trend detection model 184 are candidates for association with a media trend by determining that the distance of the output(s) satisfies one or more distance criteria (e.g., falls below a distance threshold).

Trend candidate generator 312 can identify multiple sets of media items 121 that are candidates for different media trends, in accordance with embodiments described above. Trend candidate selector 314 can select a respective set of media items 121 identified by trend candidate generator 312 that define or are otherwise associated with a media trend of platform 120. In some embodiments, trend candidate selector 314 can select a respective set of media items 121 to be associated with a media trend by determining that the respective set of media items 121 satisfy one or more media trend criteria. The media trend criteria can be defined by a developer or operator of platform 120 and can relate to commonalties of detected media trends. In an illustrative example, a media trend criterion can be that a set of media items 121 identified as a candidate for a dance challenge media trend include a song that has characteristics associated with songs for other dance challenge media trends (e.g., high tempo, upbeat lyrics, etc.). A developer or operator of platform 120 can provide the media trend criteria to trend candidate selector 314, in some embodiments, and trend candidate selector 314 can select a respective set of media items 121 for association with a media trend by determining whether the set of media items 121 satisfies the media trend criteria. In other or similar embodiments, media trend selector 314 can provide, to a client device 102 associated with the developer or operator, an indication of one or more sets of media items identified as media trend candidates. The developer or operator can provide an indication a set of media items that satisfies the media trend criteria via a UI of the client device 102, in some embodiments.

Upon selecting or otherwise identifying a respective set of media items that are associated with a media trend, trend candidate selector 314 can determine trend template data 256 for the media trend based on data associated with each of the set of media items. Trend template data 256 can include embeddings indicating one or more common audio, video, and/or textual features of each of the set of media items that are unique to the media trend (e.g., compared to other media items 121 that are not associated with the trend). In some embodiments, trend candidate selector 314 can identify audiovisual embeddings and/or the textual embeddings representing one or more visual features, audio features, and/or textual features that are common to each of the set of media items and can store such identified embeddings as trend template data 256 for media items 121 of the media trend.

In other or similar embodiments, trend candidate selector 314 can determine a particular media item 121 of the set of media items that originated the media trend and/or best represents the media trend. Trend candidate selector 314 can identify audiovisual embeddings and/or textual embeddings representing visual features, audio features, and/or textual features for the particular media item 121 and store such identified embeddings at memory 250 as trend template data 256. Trend candidate selector 314 can determine that the particular media item 121 originated the media trend by determining that such media item 121 was provided to platform 120 before the other media item 121 of the media trend, in some embodiments. In other or similar embodiments, trend candidate selector 314 can determine that such media item 121 originated the media trend based on creation journey data associated with the media item 121 and/or other media items 121 of the media trend. In some embodiments, creation journey data can be provided by or otherwise determined for creators of media items 121 and can indicate one or more media items 121 of platform 120 that inspired the creator to upload a respective media item 121. For example, a user of platform 120 can access a first media item of another user and determine to create and provide to platform 120 a second media item with content matching or approximately matching the content of the first media item. In such example, the first media item may be determined to be part of the “creation journey” of the second media item, as content of the first media item inspired the creation of the second media item. In some embodiments, a creator may provide an indication of media items 121 that are part of the “creation journey” of a provided media item 121 via a UI of a client device 102. Such indication can be included in creation journey data associated with the media item 121 (e.g., and stored as metadata at media item data store 252). In other or similar embodiments, trend candidate selector 314 (and/or another component of trend engine 152 or platform 120) can identify media items 121 that may be included in a creation journey associated with a media item 121 provided by a creator by identifying media items 121 that the creator accessed prior to providing their media item 121. In some embodiments, trend candidate selector 314 can parse creation journey data associated with each of the set of media items identified for the media trend and can identify a particular media item 121 that satisfies one or more creation journey criteria (e.g., is included in a threshold number of creation journeys of the set of media items) as best representing the media trend.

As indicated above, trend maintenance module 212 can perform one or more operations associated with trend maintenance, including detecting newly uploaded media items 121 that correspond to a detected media trend and, if needed, updating trend template data 256 for the trend based on an evolution of the media trend over time. In some embodiments, platform 120 can receive a media item 121 from a client device of a creator for sharing with other users of the platform. Upon receiving the media item 121, embedding generator 310 may generate a set of audiovisual embeddings and/or a set of textual embeddings for the media item 121, as described herein. Trend maintenance module 212 can provide the generated embeddings for the media item 121 as an input to one or more AI models 182. In some embodiments, the one or more AI model(s) 182 can include a trend maintenance model 186, which can be trained to determine whether a media trend 121 uploaded to platform 120 is part of a detected media trend (e.g., detected by trend identification module 210). In some embodiments, trend maintenance module 212 can provide the embeddings for the media item 121 as an input to the trend maintenance model 186 and can obtain one or more outputs, which can indicate whether the media item 121 is associated with a detected media trend. Responsive to determining, based on the one or more outputs of the trend maintenance model 186, that the media item 121 is associated with a detected trend, trend maintenance module 212 can update media item data store 252 to include an indication that media item 121 is associated with the detected trend.

In some embodiments, trend maintenance module 212 may determine that one or more features (e.g., video feature, audio feature, etc.) of a user provided media item 121 may correspond to a feature of media items 121 associated with a detected media trend. In such embodiments, trend maintenance module 212 may identify the trend template data 256 associated with the detected media trend and may provide the embeddings of the identified trend template data 256 as an input to trend template model 186 (e.g., with the embeddings for the user provided media item 121. In such embodiments, trend maintenance model 186 can provide one or more outputs that indicate a distance between features of the user provided media item 121 and features indicated by the provided embeddings associated with the media trend. Trend maintenance module 212 can determine whether the user provided media item 121 is associated with the media trend by determining whether the distance indicated by the one or more outputs satisfies one or more distance criteria (e.g., falls below a distance threshold).

In some embodiments, prior to providing the embeddings for the user provided media item 121 and the embeddings associated with the media trend as an input to the trend maintenance model 186, trend maintenance module 212 can determine a degree of alignment between the embeddings of the user provided media item 121 and the embeddings associated with the media trend. For example, trend maintenance module 212 can provide the embeddings of the user provided media item 121 and the embeddings associated with the media trend as an input to an alignment function (e.g., a dynamic time warping function) and can obtain, based on one or more outputs of the alignment function, an indication of a degree of alignment between one or more visual features of the user provided media item 121 and visual features represented by the embeddings for the media trend. Trend maintenance module 212 can provide the indicated degree of alignment as an input to trend maintenance model 186, which can further inform trend maintenance model 186 of the similarities and/or distance between content of the user provided media item 121 and media items 121 of the media trend. In other or similar embodiments, trend maintenance model 186 can predict the degree of alignment between the embeddings provided as an input, and the output(s) of the trend maintenance model 186 can indicate the predicted degree of alignment.

As indicated above, trend maintenance module 212 can continuously compare features of newly uploaded media items 121 to features of media items 121 associated with detected media trends to determine whether such newly uploaded media items 121 are associated with a respective media trend. In some embodiments, trend maintenance module 212 can detect that a distance between features of media items 121 associated with a detected media trend and features of newly uploaded media items 121 determined to be associated with a media trend changes overtime. For example, trend maintenance module 212 can detect that a distance value included in the output(s) of trend maintenance module 212, while still satisfying the distance criteria, are increasing overtime. Such change can indicate to trend maintenance module 212 that the media trend may be evolving since the initial identification of the media trend. In some embodiments, trend maintenance module 212 may transmit an instruction to trend identification module 210 to perform one or more media trend identification operations with respect to the newly updated media items 121 of which the deviation from the media trend is detected. Trend identification module 210 can perform the media trend identification operations with respect to such media items 121 and can determine (e.g., based on the clustering operations performed by trend candidate generator 312) whether a new media trend is detected among such media items 121. In response to determining that the new media trend is detected, trend identification module 210 can update trend template data 256 associated with the media trend to include one or more features (e.g., visual features, audio features, textual features, etc.) for such media items 121. In some embodiments, trend maintenance module 212 can perform trend maintenance operations with respect to newly uploaded media items 121 based on the updated trend template data 256 for the media trend.

Trend exploration module 214 can perform one or more operations associated with trend exploration, which can include, in some embodiments, determining a context and/or a purpose of a detected media trend and/or identifying features of media items 121 of the detected media trend of which particular audiences of users are particularly interested. In some embodiments, trend exploration module 214 can determine the context and/or purpose of the detected media trend upon detection of the media trend. For example, trend identification module 210 can detect a new media trend among media items 121 of media item store 252, as described herein, but at the time of detection, trend engine 152 may be unaware of the context or purpose of the media trend. Trend exploration module 214 can compare features of trend template data 256 (e.g., as determined for the media trend by trend identification module 210) to features of media items 121 for other media trends for which the context or purpose is known. Upon determining that one or more features (e.g., visual features, audio features, etc.) indicated by the trend template data 256 corresponds to (e.g., matches or approximately matches) features for the media items 121 for the other media trends, trend exploration module 214 can determine that the context or purpose of the detected media trend matches the context or purpose of the other media trends. In an illustrative example, the features of the trend template data can indicate that the audio signal of media items 121 of a detected media trend includes a steady beat, a fast tempo, a high or medium degree of syncopation, and so forth. Trend exploration module 214 can compare these features to features of media items 121 associated with other media trends at platform 120 and can determine, based on the comparison, that features of the detected media trend match features of media items 121 for dance challenge trends. Therefore, trend exploration module 214 can determine that the context or purpose of the detected media trend is a dance challenge. In some embodiments, trend exploration module 214 can update trend template data 256 to include an indication of the determined context or purpose for the detected media trend.

Trend exploration module 214 can also collect trend metrics 258 for a respective media trend, which includes data indicating user engagement associated with media items 121 of a particular media trend. User engagement can include, but is not limited to, viewership engagement (e.g., a number of times the media item 121 has been watched, the amount of time users spend watching the media item 121, the percentage of users who watch the entire media item 121, etc.), interaction engagement (e.g., approval or disapproval expressions provided by users, comments provided by users, a number of times users have shared the media item 121 with other users, etc.), social engagement (e.g., mentions or tags associated with the media item 121 in social media posts or comments, etc.), user retention engagement (e.g., the number of users that rewatch the media item 121, etc.), interactive engagement (e.g., user engagement with polls or quizzes associated with the media item 121), feedback engagement (e.g., user responses in surveys, reviews, etc. associated with the media item 121), and so forth. In some embodiments, trend exploration module 214 can collect user engagement data for each media item 121 associated with a respective media trend 121 determined to be associated with a media trend and can aggregate the collected user engagement data for each media trend as one or more media trend metrics 258. In an illustrative example, a media trend metric 258 for a respective media trend can indicate a factor of component of user engagement across all media items 121 associated with the respective media trend. In some embodiments, trend metrics 258 can also include data or other information associated with the characteristics of users and/or client devices that are accessing and/or engaging with media items 121 of the media trend and/or are not accessing and/or engaging with media items 121 of the media trend.

In some embodiments, trend exploration module 214 can detect when a previously detected media trend has become inactive or unsuccessful. An inactive media trend refers to a media trend of which a degree or frequency of association with newly uploaded media items 121 within a particular time period falls below a threshold degree or a threshold frequency. An unsuccessful media trend refers to a media trend of which values of media trend metrics 258 (e.g., pertaining to user access and/or user engagement) satisfy one or more unsuccessful trend criteria. For example, trend exploration module 214 can determine that a media trend is unsuccessful upon determining that an aggregate number of users that have shared media items 121 of the media trend falls below a threshold number. In another example, trend exploration module 214 can determine that a media trend is unsuccessful upon determining that an aggregate number of disapproval expressions (e.g., “dislikes”) for media items 121 of the media trend exceeds a threshold number and/or an aggregate number of approval expressions (e.g., “likes”) for media items 121 of the media trend falls below a threshold number. Upon determining that a media trend has become inactive or unsuccessful, media item manager 132 (or another component or module of trend engine 152) can perform one or more operations to update trend template data 256 to indicate that the media trend is an inactive or an unsuccessful media trend. In some embodiments, trend engine 152 can remove trend template data 256 for the inactive or unsuccessful media trend from memory 250 based on the indication.

Trend discovery module 216 can perform one or more operations associated with trend discovery, which can include surfacing media trends and/or media items 121 associated with particular media trends to users, alerting media item creators that their media item 121 has initiated or is part of a media trend, and/or providing creators with access to tools to enable the creators to control the use or distribution of their media item 121 in accordance with the media trend. As illustrated in FIG. 3, trend discovery module 216 can include a viewer discovery component 316 and/or a creator discovery component 318. As described herein, media item manager 132 can provide a user with access to media item 121 (e.g., upon receiving a request from a client device 102 of the user). In some embodiments, viewer discovery component 316 can detect that a media item 121 to be provided to a client device 102 is determined to be associated with a detected media trend, in accordance with previously described embodiments, and can provide a notification to the client device 102 (e.g., with the media item 121) indicating that the media item 121 is associated with the media trend. In some embodiments, viewer discover component 316 can also provide a user with an indication of one or more additional media items 121 associated with the media trend (e.g., in response to a request from the client device 102).

As described above, trend identification module 210 can identify one or more media items 121 that originated or created a media trend. In some embodiments, creator discovery component 318 can provide a notification to creators associated with the identified media item(s) 121 that their media item 121 is determined to have originated or created the media trend. For example, upon identification of the one or more media items 121, creator discovery component 318 can determine an identifier for a user and/or a client device 102 that provided the media item 121 and can transmit the notification to the client device 102 associated with the user. In some embodiments, the creator discovery component 318 can additionally or alternatively provide to the client device 102 one or more UI elements that enable the creator to control the user or distribution of their media item 121 in accordance with the media trend. For example, the one or more UI elements can enable the creator to prevent or limit notifying other users accessing the media item 121 that the media item 121 is associated with the media trend. In another example, the one or more UI elements can enable the creator to prevent or limit sharing of the media item 121 between other users of platform 120. In some embodiments, creator discovery component 318 can update media item data store 252 to indicate the preferences provided by the creator (e.g., based on user engagement with the one or more UI elements). Viewer discovery component 316 and/or media item manager 132 can provide access to the media item 121 and/or enable sharing of the media item 121 in accordance with the creator preferences, in some embodiments.

FIG. 4 is a block diagram of an example method 400 for media trend detection of content sharing platforms, in accordance with implementations of the present disclosure. Method 400 can be performed by processing logic that can include hardware (circuitry, dedicated logic, etc.), software (e.g., instructions run on a processing device), or a combination thereof. In one implementation, some or all the operations of method 400 can be performed by one or more components of system 100 of FIG. 1. In some embodiments, some or all of the operations of method 400 can be performed by trend engine 152. For example, some or all of operations of method 400 can be performed by one or more components of trend identification module 210 (e.g., embedding generator 310, trend candidate generator 312, and/or trend candidate selector 314) and/or trend maintenance module 212.

It should be noted that although some examples and embodiments of the following sections are described with respect to embedding generator 310 and media trend detection, such examples and embodiments are provided for the purpose of explanation and illustration only. Such examples and embodiments can be performed by any component or module of trend engine 152, platform 120, system 100, and/or one or more other systems (not illustrated). Further, such examples and embodiments can be performed for any media characterization task, in accordance with embodiments described herein.

At block 402, processing logic identifies a media item including a sequence of video frames. In some embodiments, processing logic can obtain the set of audiovisual embeddings for a media item 121 provided by a creator of platform 120. Processing logic can obtain the set of audiovisual embeddings upon (or soon after) receipt of the media item 121 from a client device 102 of the creator, in some embodiments. In other or similar embodiments, embedding generator 310 can obtain the set of audiovisual embeddings upon receiving an instruction from another module or component of platform 120 (e.g., from trend maintenance module 212, from trend exploration module 214, etc.). Such module or component of platform 120 may transmit the instruction to processing logic in accordance with embodiments described above and/or in accordance with a schedule of a media characterization protocol (e.g., as defined by a developer or operator of platform 120).

FIG. 5 illustrates an example of generating an embedding for media trend detection of content sharing platforms, in accordance with implementations of the present disclosure. As described above, a media item 121 can include or be made up of a sequence of video frames 502 that each depict a still image of content associated with the media item 121. Each video frame, in some embodiments, can include a pixel array composed of pixel intensity data associated with visual features of the media item 121. When played in sequence with other frames 502 of the media item 121, the frames 502 depict motion on a playback surface (e.g., a UI of client device 102). In some embodiments, each video frame 502 may be associated with a segment of audio data 504. When played in sequence with frames 502, the audio data 504 provides an audio signal corresponding to the playback of the frames 502. As described herein, the sequence of video frames 502 may be generated by a camera component (e.g., a camera) of a client device 102 or another device of system 100.

Referring back to FIG. 4, at block 404, processing logic obtains a set of video embeddings representing visual features of the sequence of video frames. Embedding generator 310 can obtain the set of video embeddings 506 based on one or more outputs of an image encoder 510. An image encoder refers to an AI model (or a component of an AI model) that transforms raw image data into a structured, high-dimensional representation (e.g., a feature vector) of features or information of the image. An image encoder 510 can take an image, such as a video frame 502, as an input and can extract features from the input image by applying a series of filters to capture various aspects of the image, such as edges, textures, colors, patterns, and so forth. The filters applied to the input image and/or the aspects of the image captured by the image encoder 510 may be defined and/or specified based on the training of the image encoder 510. In some embodiments, image encoder 510 is employed using a deep learning approach, such as that of a convolutional neural network (CNN) architecture. In such embodiments, the image encoder 510 can include or be made up of a network including multiple layers, such as a convolutional layer (e.g., which applies various filters to the image to create feature maps highlighting different features at various scales), an activation function layer (e.g., which introduces non-linearities into the network, allowing it to learn more complex patterns), a pooling layer (e.g., which reduces the dimensionality of the feature maps, which enable the representation to be abstract and invariant to small changes in the input image), and/or a normalization layer (e.g., which stabilize the learning process and improve the convergence of training of the image encoder 510). In some embodiments, an output of the image encoder 510 can include a feature vector (or a set of feature vectors) that represent the content of the input image in a compressed and informative way. In some embodiments, the image encoder 510 can include a vision transformer, a visual geometry group deep convolutional network (VGGNet) encoder, a residual network (ResNet) encoder, an inception encoder, an autoencoder, and so forth.

As indicated above, embedding generator 310 can provide one or more image frames 502 of media item 121 as an input to image encoder 510 and can obtain the set of video embeddings 506 based on one or more outputs of the image encoder 510. Each of the set of video embeddings 506 can include or correspond to a frame token, which refers to a unit of processed information output by an image encoder 510. Each frame token can represent the features of one or more frames 502 of the media item 121, in some embodiments. In some embodiments, embedding generator 310 can store the set of video embeddings 506 at memory 250, which can include or otherwise reference the frame tokens.

Referring back to FIG. 4, at block 406, processing logic obtains a set of audio embeddings representing audio features of the sequence of video frames. Embedding generator 310 can obtain the set of audio embeddings 508 based on one or more outputs of audio encoder 512. An audio encoder 512 refers to an AI model or engine that converts an audio signal into a vector representation that captures the audio features of the input audio data. In some embodiments, audio encoder can include an audio spectrogram transformer, which processes audio data by converting it to a spectrogram (e.g., a visual or numerical representation of an audio signal's frequency spectrum over time) and uses a transformer architecture to extract meaningful features from the audio, such as the audio features described herein. Embedding generator 310 can provide audio data 504 of media item 121 as an input to audio encoder 512 and can obtain the set of audio embeddings 508 based on one or more outputs of the audio encoder 512. Each of the set of audio embeddings 508 can correspond to a segment of audio for a frame 502. In some embodiments, embedding generator 310 can store the set of audio embeddings 508 at memory 250.

At block 408, processing logic generates a set of audiovisual embeddings based on the set of video embeddings and the set of audio embeddings. In some embodiments, embedding generator 310 can provide the set of video embeddings 506 and the set of audio embeddings 508 as an input to a concatenation engine 514. Concatenation engine 514 can perform one or more concatenation operations to concatenate each frame token of the set of video embeddings 506 with a corresponding audio embedding of the set of audio embeddings 508. Based on the concatenation operations, embedding generator can generate the set of audiovisual embeddings 516. As illustrated by FIG. 5, the set of audiovisual embeddings 516 includes each frame token of the set of video embeddings 506 concatenated with each corresponding audio embedding of the set of audio embeddings 508.

In some embodiments, embedding generator 310 can additionally or alternatively perform one or more attention pooling operations to the concatenated video and audio embeddings. An attention pooling operation refers to an operation that reduces the dimensionality of a feature map, which enables the output representation to be abstract and invariant to small changes. In some embodiments, the attention pooling operations can include a generative pooling operation and/or a contrastive pooling operation. In some embodiments, embedding generator 310 can provide the concatenated video and audio embeddings as an input to the one or more attention pooling operations and can obtain the set of audiovisual embeddings 516 based on one or more outputs of the attention pooling operation(s).

Referring back to FIG. 4, at block 410, processing logic, optionally, obtains a set of textual embeddings representing textual features associated with content of the sequence of video frames. In some embodiments, embedding generator 310 can obtain the set of textual embeddings 518 based on one or more outputs of a text encoder 520. A text encoder refers to an AI model (or a component of an AI model) that transforms raw text into a fixed, high-dimensional representation (e.g., a feature vector) of semantic properties of the input text. A text encoder 520 can take text as an input and can break down the input text into smaller components, such as words, subwords, or characters (e.g., tokens). Text encoder 520 can then map each token to a vector in a high-dimensional space, which are learned to capture semantic and syntactic meanings of the words (e.g., according to a training of the text encoder 520). Text encoder 520 can update or adjust the token embeddings based on the context in which they appear in the text and can combine the contextual embeddings of the individual tokens into a single or sequence of vectors that represent larger units of text (e.g., sentences, paragraphs, entire documents, etc.). In some embodiments, text encoder 520 can be or otherwise include a recurrent neural network (RNN), a convolutional neural network (CNN), a transformer, a pre-trained language model (e.g., a Bidirectional Encoder Representations from Transformers (BERT) model, a Generative Pre-trained Transformer (GPT) model, etc.), and so forth.

In some embodiments, embedding generator 310 can provide textual data 522 associated with the media item 121 as an input to text encoder 520 and can obtain the set of textual embeddings 518 as an output of the text encoder 520. The textual data 522 can include information pertaining to the content of the media item 121. For example, textual data 522 can include a title of the media item 121, a caption of the media item 121 (e.g., as provided by a creator of the media item 121), one or more tags or keywords associated with the media item 121 (e.g., as provided by the creator or another system or process associated with platform 120), and so forth. In other or similar embodiments, textual data 522 can include or otherwise reference a transcript of an audio of the media item 121, comments provided by one or more users (e.g., viewers) of the media item 121, search queries associated with media item 121, and so forth.

Each of the set of textual embeddings 518 obtained based on output(s) of the text encoder 520 can include or correspond to a text token, which refers to a unit of processed information output by a text encoder 520. Each text token can represent features of one or more segments of text (e.g., a word, a subword, a character, a sentence, a paragraph, etc.) of textual data 522. In some embodiments, the set of textual embeddings 518 can include a single text token that represents the entirety of the textual data 522. In other or similar embodiments, the set of textual embeddings 518 can include multiple text tokens that each represent a distinct segment of textual data 522.

As illustrated by FIG. 5, embedding generator 310 can generate fused textual-audiovisual data 524 based on the set of audiovisual embeddings 516 and the set of textual embeddings 518. In some embodiments, fusion engine 526 can perform one or more concatenation operations to concatenate the set of textual embeddings 518 to each respective frame token and audio embedding of the set of audiovisual embeddings 516 to generate a set of concatenated textual and audiovisual embeddings. In additional or alternative embodiments, fusion engine 526 generate a set of frame tokens based on the set of concatenated textual and audiovisual embeddings, where each respective frame token represents a correspondence between a respective video embedding, a respective audio embedding, and the set of textual embeddings. In some embodiments, fusion engine 526 can include or otherwise implement a transformer encoder. A transformer encoder is an AI model (or is a component of an AI model) that transforms input data into a continuous representation (e.g., feature vector) that retains semantic meaning and relational information between different parts of the input. In some embodiments, a transformer encoder can include a stack of identical layers that each contain a multi-head self-attention mechanism and a position-wise feed-forward network. The multi-head self-attention mechanism of each layer allows the model to weigh the importance of different input elements (e.g., video tokens, audio embeddings, text tokens, etc.), irrespective of their positions in the input sequence. Such mechanism also splits the self-attention process into multiple “heads,” allowing the model to jointly attend to information from different representation subspaces at different positions. Fusion module 526 can provide the set of concatenated textual and audiovisual embeddings as an input to the transformer encoder and can obtain a set of frame tokens as an output of the transformer encoder. The fused textual-audiovisual data 524 can include the obtained set of frame tokens.

In some embodiments, fusion module 526 can generate a feature pyramid 528 based on the set of frame tokens. A feature pyramid 528 refers to a collection of data that is generated based on audiovisual embeddings and is a multi-scale representation of content associated with the audiovisual features of the audiovisual embeddings. A feature pyramid 528 has a hierarchical structure where each level of the pyramid represents features at a different scale, with higher levels having coarser (e.g., lower resolution but semantically stronger) features and lower levels having finer (e.g., higher resolution but semantically weaker) features. In some embodiments, the highest level of the feature pyramid 528 includes embeddings associated with an entire image (e.g., of an image frame 502) and/or large portions of the image, which provides the high-level semantic information pertaining to content of the image (e.g., the presence of an object). As indicated above, embeddings of the highest level have the lowest resolution but cover the largest field of view of the content. Intermediate levels of the feature pyramid 528 progressively increase in resolution and decrease in field of view. The lowest level of the feature pyramid 528 includes embeddings with the highest resolution, and depict small regions of the image to capture fine details of the overall image. In some embodiments, the feature pyramid 528 can include or correspond to a Feature Pyramid Network (FPN), which includes connections between features from different scales.

Fusion module 526 can generate the feature pyramid by performing one or more sampling operations with respect to the frame tokens output by the transformer encoder. The one or more sampling operations can include down sampling operations, which reduce the resolution of input frame tokens and/or upsampling operations, which increase the resolution of input frame tokens. In some embodiments, a down sampling operation can include or involve pooling or strided convolutions in a convolutional neural network to reduce dimensionality of the features associated with an input frame token. In additional or alternative embodiments, an upsampling operation can involve bilinear interpolation, transposed convolutions, and/or learnable upsampling to recover spatial resolution of the input frame token.

In an illustrative example, the highest level of the feature pyramid 528 can include the frame tokens output by the transformer encoder. Fusion module 526 can perform one or more down sampling operations with respect to the frame tokens to generate one or more intermediate layers of the feature pyramid 420. To generate each lower level of the feature pyramid 528, fusion module 526 may perform a down sampling operation with respect to the frame token of the level directly above the lower level. Each token of the feature pyramid 528 (including the tokens of the highest level) are referred to herein as sampled tokens.

Referring back to FIG. 4, at block 412, processing logic determines one or more media characteristics associated with the media item based on the set of audiovisual embeddings. In some embodiments, processing logic can also determine the one or more media characteristics based on the set of textual embeddings for the media item. As described herein, the one or more media characteristics can include, but is not limited to, whether the media item 121 is associated with a media trend of platform 120, a degree of interest in content of media item 121 by one or more users of platform 120, an image quality and/or an audio quality of the media item, and so forth.

In some embodiments, processing logic (e.g., trend identification module 210 and/or trend maintenance module 212) can determine whether media item 121 is associated with a media trend of platform 120 by providing the audiovisual embeddings 516, the textual embeddings 518, the fused textual-audiovisual data 524, and/or the feature pyramid 528 as an input to one or more of AI model(s) 182 (e.g., trend detection model 184, trend maintenance model 186). As described above, trend detection module 184 can be trained to determine whether a new media trend has emerged with respect to media items 121 uploaded to platform 120 and trend maintenance model 186 can be trained to predict whether a newly uploaded media item 121 is part of a media trend previously detected at platform 120.

In some embodiments, trend candidate generator 312 can provide the set of audiovisual embeddings 516 and the set of textual embeddings 518 as an input to trend detection model 184 and can obtain one or more outputs of the trend detection model 184. The one or more outputs can indicate a distance between each of the set of media items 121 of an identified cluster or group, as described above. The distance indicated by the model outputs can indicate a distance between of the visual or audio features for each of the set of media items 121, in view of the textual features associated with such media items 121. Trend candidate generator 312 can determine that a set of media items 121 (e.g., including the media item 121 of which the embeddings were obtained) may be associated with a new media trend has emerged by determining that the distance indicated by the one or more outputs of the trend detection model 184 satisfies one or more distance criteria. A distance can satisfy the one or more distance criteria if the distance falls below a threshold distance, in some embodiments.

In other or similar embodiments, trend maintenance module 212 can provide the set of audiovisual embeddings 516 and the set of textual embeddings 518 as an input to trend maintenance model 186 and can obtain one or more outputs of the trend maintenance model 186. The outputs of trend maintenance model 186 can indicate a level of confidence that audiovisual features of the media item 121 correspond to audiovisual features of one or more additional media items 121 associated with a previously detected media trend. In some embodiments, the outputs of the trend maintenance model 186 can indicate multiple detected media trends and, for each media trend, a level of confidence that the media item 121 is associated with such media trend. Trend maintenance module 212 can determine that the media item 121 of which the embeddings are obtained is associated with a previously detected media trend by determining that the level of confidence indicated by the one or more outputs of the trend maintenance model 186 satisfies one or more confidence criteria (e.g., exceeds a threshold level of confidence, is higher than other levels of confidence associated with other media trends, etc.). Upon determining that the media item 121 is associated with the one or more media trends, trend maintenance module 212 can update metadata for the media item 121 (e.g., at media item data store 252) to indicate that the media item 121 is associated with the media trend.

As described above, processing logic can determine one or more other media characteristics associated with media item 121 based on the set of audiovisual embeddings 516 and/or the set of textual embeddings 518. For example, processing logic can recommend identify media items that are likely to be of interest to users by obtaining audiovisual embeddings 516 and/or textual embeddings 518 for media items 121 that the users have previously expressed interest in (e.g., by engaging with the media item 121, etc.) and comparing such audiovisual embeddings 516 and/or textual embeddings 518 to audiovisual embeddings 516 and/or textual embeddings 518 associated with other media items 121 of media item data store 252 (e.g., that the user has not accessed). In another example, processing logic can generate or otherwise obtain data representing media items 121 of interest to a user by performing one or more clustering operations (e.g., K-means clustering, etc.) based on audiovisual embeddings 516 and/or textual embeddings 518 for media items 121 previously accessed by the user. In yet another example, processing logic can predict a quality of a media item (e.g., a degree of noise, a degree of distortion, etc.) based on an AI model that is trained using a training data set including audiovisual embeddings 516 and/or textual embeddings 518 for a respective media item 121 and an indication of a quality metric for the respective media item 121 (e.g., indicating a calculated or user-provided degree of noise, a calculated or user provided degree of distortion, etc.). Processing logic can provide embeddings for newly uploaded media items 121 as an input to the trained AI model and can determine a predicted video quality for the media item 121 based on one or more outputs of the AI model.

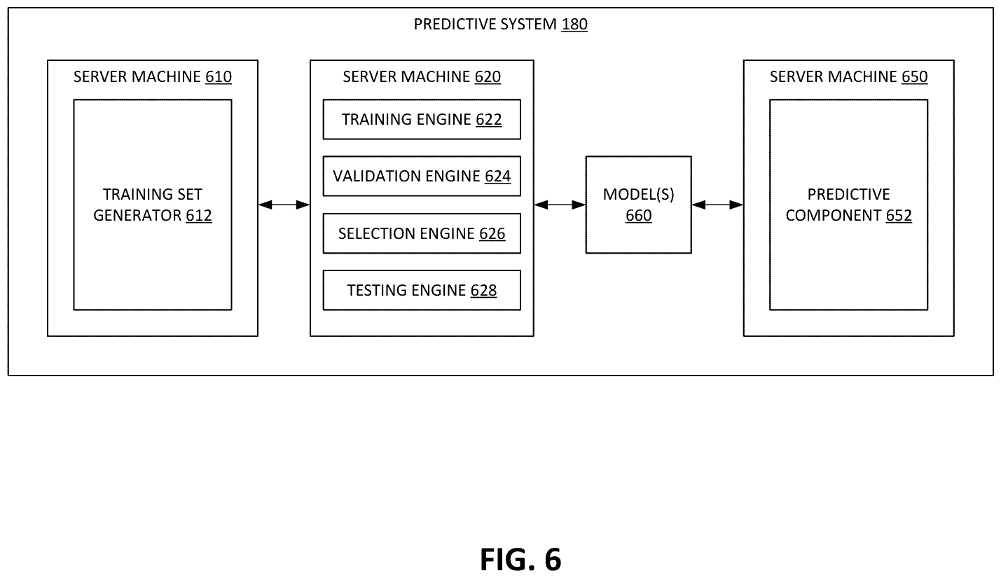

FIG. 6 is a block diagram of an illustrative predictive system, in accordance with implementations of the present disclosure. As illustrated in FIG. 6, predictive system 180 can include a training set generator 612 (e.g., residing at server machine 610), a training engine 612, a validation engine 624, a selection 626, and/or a testing engine 628 (e.g., each residing at server machine 620), and/or a predictive component 652 (e.g., residing at server machine 650). Training set generator 612 may be capable of generating training data (e.g., a set of training inputs and a set of target outputs) to train one or more AI model 660. In some embodiments, AI model 660 can include image encoder 510, audio encoder 512, and/or text encoder 520.

Training set generator 612 can generate a training dataset to train the image encoder 510 by obtaining a set of training videos and a set of feature data indicating visual features of the training videos. The visual features indicated by the set of feature data can include visual features for media items 121, as described herein. The set of training videos can be obtained from a publicly accessible data store or a privately accessible data store. In some embodiments, the set of feature data can be stored with the training videos. In such embodiments, training set generator 612 can obtain the set of feature data from the data store that stores the set of training videos. In other or similar embodiments, training set generator 612 can generate the set of feature data for the set of training videos. For example, training set generator 612 can provide a respective training video as an input to one or more other machine learning models trained to extract particular features of a given input video. Training set generator 612 can obtain the features for the training video based on one or more outputs of the other machine learning models and can include such features in the set of feature data. In yet other or similar embodiments, the set of training videos and the set of feature data can be provided to training set generator 612 by a developer or operator of platform 120.

In some embodiments, training set generator 612 can generate an input-output mapping based on the obtained set of training videos and the obtained set of feature data. An input of the input-output mapping can include a respective training video of the set of training videos and the output of the input-output mapping can include feature data pertaining to the respective training video. In some embodiments, an input-output mapping can be generated for a respective training video, or a segment (e.g., a video frame) of the respective training video. Training set generator 612 can update a training dataset to include the generated input-output mapping, in some embodiments.

Training set generator 612 can generate a training dataset to train the audio encoder 512 by obtaining a set of training audio signals and a set of feature data indicating audio features of the training audio signals. The audio features indicated by the set of feature data can include audio features for media items 121, as described herein. The set of training audio signals can be obtained from a publicly accessible data store or a privately accessible data store. In some embodiments, the set of training audio signals can include audio signals associated with videos of the set of training videos, as described above. In some embodiments, the set of feature data can be stored with the training audio signals and/or training videos. In such embodiments, training set generator 612 can obtain the set of feature data from the data store that stores the set of training audio signals and/or training videos. In other or similar embodiments, training set generator 612 can generate the set of feature data for the set of training audio signals. For example, training set generator 612 can provide a respective training audio signals as an input to one or more other machine learning models trained to extract particular features of a given input audio signals. Training set generator 612 can obtain the features for the training audio signals based on one or more outputs of the other machine learning models and can include such features in the set of feature data. In yet other or similar embodiments, the set of training audio signals and the set of feature data can be provided to training set generator 612 by a developer or operator of platform 120.

In some embodiments, training set generator 612 can generate an input-output mapping based on the obtained set of training audio signals and the obtained set of feature data. An input of the input-output mapping can include a respective training audio signal of the set of training audio signals and the output of the input-output mapping can include feature data pertaining to the respective training audio signal. In some embodiments, an input-output mapping can be generated for a respective training audio signal, or a segment (e.g., audio sequence) of the respective training audio signal. Training set generator 612 can update a training dataset to include the generated input-output mapping, in some embodiments. In some embodiments, the training dataset for training the image encoder 510 can be the same or different from the training dataset for training the audio encoder 512.

Training set generator 612 can generate a training dataset for training text encoder 520 by obtaining a set of textual data for one or more media items (e.g., video items, audio items, etc.) and a set of textual features for the obtained set. Training set generator 612 can obtain the set of textual data and the set of textual features in accordance with embodiments described above. In some embodiments, the set of textual data and the set of textual features can be associated with the training videos and/or training audio signals described above. In other or similar embodiments, the set of textual data and the set of textual features can be associated with other media items.

In some embodiments, training set generator 612 can generate an input-output mapping based on the obtained set of textual data and the obtained set of textual features. An input of the input-output mapping can include a respective textual data for a media item and the output of the input-output mapping can include one or more textual features pertaining to the respective textual data. Training set generator 612 can update a training dataset to include the generated input-output mapping, in some embodiments. In some embodiments, the training dataset for training the text encoder 520 image encoder 510 can be the same or different from the training dataset for training the video encoder 510 and/or the audio encoder 512.

Training engine 622 can train an AI model 660 using the training data from training set generator 612. The AI model 660 can refer to the model artifact that is created by the training engine 622 using the training data that includes training inputs and/or corresponding target outputs (correct answers for respective training inputs). The training engine 622 can find patterns in the training data that map the training input to the target output (the answer to be predicted), and provide the AI model 660 that captures these patterns. The AI model 660 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like.

Validation engine 624 may be capable of validating a trained machine learning model 182 using a corresponding set of features of a validation set from training set generator 612. The validation engine 624 may determine an accuracy of each of the trained machine AI 660 based on the corresponding sets of features of the validation set. The validation engine 624 may discard a trained AI model 660 that has an accuracy that does not meet a threshold accuracy. In some embodiments, the selection engine 626 may be capable of selecting a trained machine learning model 182 that has an accuracy that meets a threshold accuracy. In some embodiments, the selection engine 626 may be capable of selecting the trained AI model 660 that has the highest accuracy of the trained AI models 660.

The testing engine 686 may be capable of testing a trained AI model 660 using a corresponding set of features of a testing set from training set generator 612. For example, a first trained machine learning model 182 that was trained using a first set of features of the training set may be tested using the first set of features of the testing set. The testing engine 628 may determine a trained machine learning model 182 that has the highest accuracy of all of the trained machine learning models based on the testing sets.

As described above, predictive component 652 of server 650 may be configured to feed data as input to model 182 and obtain one or more outputs. In some embodiments, predictive component 652 can include or be associated with trend candidate generator 312 and/or trend maintenance model 212. In such embodiments, predictive component 652 can feed video frames 502, audio data 504, and/or textual data 522 for a media item 121 as an input to model 182, in accordance with previously described embodiments.

In some embodiments, image encoder 510 and/or audio encoder 512 can be based on a pretrained image-text model (e.g., a contrastive captioner (CoCa) model) that is trained to perform video-text tasks. Predictive system 180 can obtain such pretrained model from a publicly accessible database and/or a private database. In such embodiments, predictive system 180 can train image encoder 510 and/or audio encoder 512 by performing one or more finetuning operations using the training dataset, as described above.

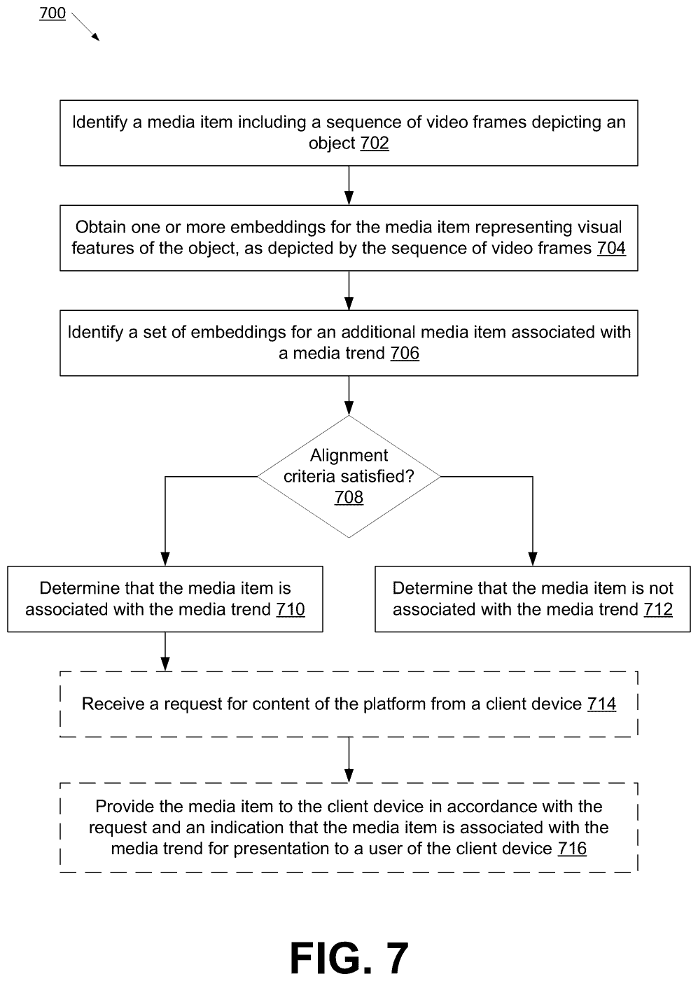

FIG. 7 is a block diagram of an example method 700 for media item characterization, in accordance with implementations of the present disclosure. Method 700 can be performed by processing logic that can include hardware (circuitry, dedicated logic, etc.), software (e.g., instructions run on a processing device), or a combination thereof. In one implementation, some or all the operations of method 700 can be performed by one or more components of system 100 of FIG. 1. In some embodiments, some or all of the operations of method 700 can be performed by trend engine 152. For example, some or all of operations of method 700 can be performed by one or more components of trend identification module 210 (e.g., embedding generator 310, trend candidate generator 312, and/or trend candidate selector 314) and/or trend maintenance module 212.

It should be noted that although some examples and embodiments of the following sections are described with respect to trend engine 152 and media trend detection, such examples and embodiments are provided for the purpose of explanation and illustration only. Such examples and embodiments can be performed by any component or module of trend engine 152, platform 120, system 100, and/or one or more other systems (not illustrated). Further, such examples and embodiments can be performed for any media characterization task, in accordance with embodiments described herein.

At block 702, processing logic identifies a media item including a sequence of video frames depicting an object. Processing logic can identify the media item 121 from media item data store 252, in some embodiments. In other or similar embodiments, platform 120 can receive the media item 121 from a client device 102 associated with a creator or other user of platform 120. In some embodiments, the media item 121 can be the same media item identified with respect to operations of method 400. The media item 121 can be a different media item from the media item identified with respect to operations of method 400, in other or similar embodiments.

At block 704, processing logic obtains one or more embeddings for the media item representing visual features of the object, as depicted by the sequence of video frames. In some embodiments, the one or more embeddings can include audiovisual embeddings generated according to previously described embodiments. In such embodiments, the embeddings can represent visual features and/or audio features of the media item 121, as described above. In some embodiments, the embeddings can include audiovisual embeddings 516, fused textual-audiovisual data 524, and/or a feature pyramid 528.

In some embodiments, processing logic can extract embedding information pertaining to a pose, an action, a motion, etc. of an object depicted by the sequence of video frames of media item 121 from the embeddings generated according to previously described embodiments. For example, processing logic can identify one or more features representing the pose, action, motion, etc. of the object from the audiovisual embeddings generated for the media item 121. In some embodiments, the pose features can define or otherwise indicate a pose of the object, while the action or motion features can define or otherwise indicate the action or motion taken with respect to the object in accordance with the indicated poses. It should be noted that the processing logic can identify such features for each object depicted by the sequence of video frames. For example, if the media item 121 depicts two performers dancing, processing logic can identify features of the audiovisual embeddings for the media item 121 that represent the pose, action, and/or motion of each performer, as described above. Such identified features are referred to herein as fine-grained embeddings. As described above, feature pyramid 528 (e.g., generated by fusion module 526) can be a multi-scale representation of content associated with audiovisual features of the audiovisual embeddings 516. In some embodiments, processing logic can extract the features of the fine-grained embeddings from the lowest level of the feature pyramid 528 (or one or more levels adjacent to the lowest level of the feature pyramid 528).

In other or similar embodiments, processing logic can obtain the one or more embeddings according to other techniques. For example, processing logic can provide video frames 502 as an input to a fine-grained video embedding model, which is trained to generate such fine-grained embeddings based on a given sequence of video frames. Such model can be trained using a training dataset including training media items and fine-grained features for one or more objects of the training media items. The fine-grained features can include a pose of the one or more objects, an action of the one or more objects, a motion of the one or more objects, and so forth. Processing logic can provide video frames 502 as an input to the fine-grained video embedding model and can obtain one or more outputs of the model. The one or more outputs can include the fine-grained embeddings, as described above.

At block 706, processing logic identifies a set of embeddings for an additional media item associated with a media trend. In some embodiments, the additional media item can be stored at media item data store 252, as described above. Trend identification model 210 and/or trend maintenance model 212 may determine that the additional media item is associated with a media trend of platform 120 and can store an indication that the additional media item 121 is associated with the media trend with the media item 121 at data store 252, in accordance with embodiments described herein. In some embodiments, processing logic (e.g., embedding generator 310) can generate the embeddings for the additional media item 121 according to embodiments described above. The generated embeddings can include audiovisual embeddings 516, and/or fine-grained video embeddings, as described above. In other or similar embodiments, processing logic can identify previously generated embeddings (e.g., at media item data store 252, at another region of memory 250, etc.) for the additional media item 121 and can extract or otherwise obtain the fine-grained embeddings based on the previously generated embeddings, as described above. In yet other or similar embodiments, processing logic can determine (e.g., based on metadata for the additional media item 121 at media item data store 252) that the additional media item 121 is associated with a detected media trend. In such embodiments, processing logic can identify trend template data 256 for the media trend and can extract the fine-grained embeddings from the embeddings indicated by the identified trend template data 256, in accordance with previously described examples and embodiments.

At block 708, processing logic determines whether a degree of alignment between the visual features of the object and the visual features of the additional object satisfy one or more alignment criteria based on the set of audiovisual embeddings for the media item and the set of embeddings for the additional media item. In some embodiments, processing logic can perform one or more comparison operations to compare the features indicated by the fine-grained embeddings for the media item 121 to the fine-grained embeddings for the additional media item 121. An output of the comparison operations can indicate to processing logic a degree of alignment between the visual features of the object depicted by the media item 121 and the visual features of the additional object depicted by the additional media item 121. In some embodiments, the one or more comparison operations can include a dynamic time warping operation. A dynamic time warping operation refers to an operation or set of operations that measure the similarity between two temporal sequences that may vary in speed or time. In some embodiments, the dynamic time warping operation can be performed by one or more AI models, as described below.

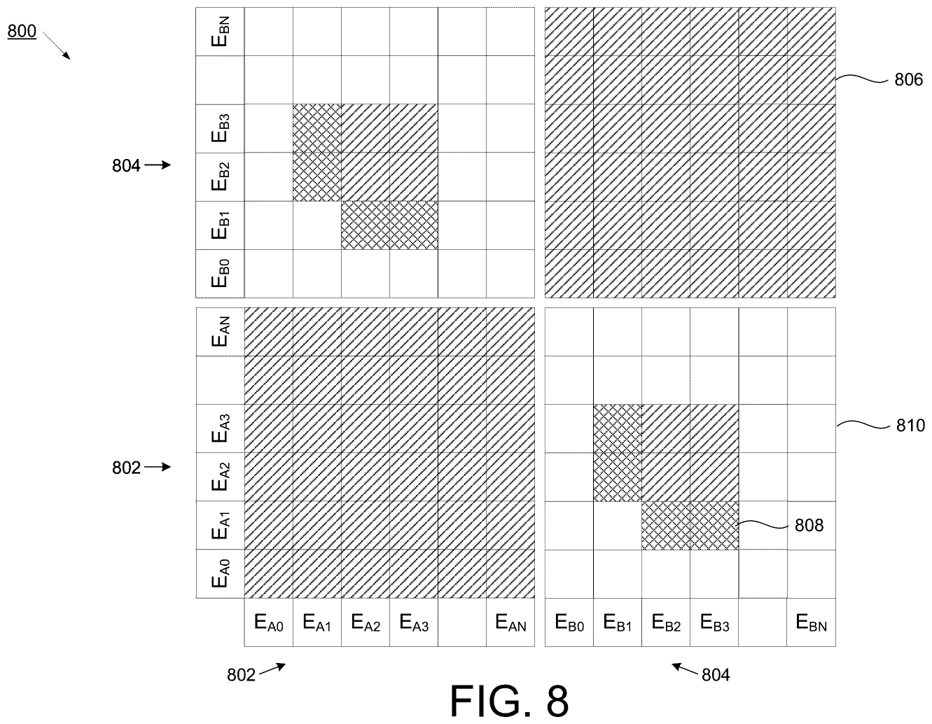

FIG. 8 depicts an example of comparing media item embeddings for media item characterization, in accordance with implementations of the present disclosure. FIG. 8 depicts a graphical representation 800 of the similarities between fine-grained video embeddings 802 for a first media item 121 and fine-grained video embeddings 804 for a second media item 121. Referring to FIG. 8, each segment (e.g., block) of the graphical representation 800 can indicate a degree of alignment between a respective fine-grained embedding on the x-axis of the graphical representation 800 and a respective fine-grained embedding on the y-axis of the graphical representation 800. A degree of alignment between respective embeddings refers to a distance or difference between visual features (e.g., poses, actions, motions) represented by such embeddings. As illustrated in FIG. 8, the degree of alignment between two embeddings such embeddings is indicated by a distinct pattern. For example, embeddings that share a high degree of alignment (e.g., exceeding a first threshold degree of alignment) are indicated by a first pattern 806, embeddings that share a medium degree of alignment (e.g., falling between the first threshold degree of alignment and a second threshold degree of alignment) are indicated by a second patter 808), and embeddings that share a low degree of alignment (e.g., falling below the second threshold degree of alignment are indicated by a third pattern 810 (e.g., or no pattern). As illustrated in FIG. 8, blocks representing the alignment between embeddings 802 on the x-axis and embeddings 802 on the y-axis share a high degree of alignment (e.g., as indicated by the first pattern 806). Similarly, blocks representing the alignment between embeddings 804 on the x-axis and embeddings 804 on the y-axis also share a high degree of alignment.

In some embodiments, processing logic can perform one or more comparison operations to determine the degree of alignment between each of the first embeddings 802 (e.g., for the media item 121 identified at block 702) and the second embeddings 804 (e.g., for the additional media item 121). An output of the one or more comparison operations can include information or data represented by graphical representation 800, in some embodiments. In some embodiments, the one or more comparison operations can involve providing first embeddings 802 and the second embeddings 804 as an input to an AI model that is trained to predict the degree of alignment between given sets of embeddings. In some embodiments, the AI model can be or can be a component of trend detection model 184 and/or trend maintenance model 186. In other or similar embodiments, the AI model can be a different AI model from trend detection model 184 and/or trend maintenance model 186. The AI model can determine the degree of alignment for each of the first embeddings 802 and the second embeddings 804, in accordance with the comparison depicted by FIG. 8 and can determine an aggregate degree of alignment between the first embeddings 802 and the second embeddings 804. The aggregate degree of alignment can be a value (e.g., a score, etc.) indicating the degree of alignment between the media items 121 associated with the first embeddings 802 and the second embeddings 804. In an illustrative example, a high value can indicate a high degree of alignment (e.g., that the content of the media items 121 are matching or approximately matching) and a low value can indicate a low degree of alignment (e.g., that the content of the media items do not match). Upon determining that the value indicated by the one or more outputs of the AI model exceeds a threshold value, processing logic can determine that the alignment criteria are satisfied.

In some embodiments, some embeddings of the first embeddings 802 can share a high degree of alignment with embeddings of the second embeddings 804, while others do not. For example, as illustrated by FIG. 8, processing logic can determine that embeddings E_{A2} and E_{A3} share a high degree of alignment with embeddings E_{B2} and E_{B3}, while other embeddings do not share a high degree of alignment. This can indicate that one or more poses or motions represented by embeddings E_{A2} and E_{A3} are the same as or similar to poses or motions represented by embeddings E_{B2} and E_{B3}. In some embodiments, one or more outputs of the comparison operations can indicate the embeddings of embeddings 802 and embeddings 804 that share the high degree of alignment. Processing logic may determine that the alignment criteria are satisfied with respect to such embeddings, in accordance with previously described embodiments.

Referring back to FIG. 7, responsive to a determination that the one or more alignment criteria are satisfied, method 700 can proceed to block 410. At block 410, processing logic can determine that the media item is associated with the media trend. As indicated above, a determination that the one or more alignment criteria are satisfied can indicate that the visual features of the media item 121 are the same or similar as visual features of the additional media item 121 associated with the media trend. In some embodiments, processing logic can therefore determine that the media item 121 is associated with the media trend responsive to determining that the one or more alignment criteria are satisfied. In other or similar embodiments, upon determining that the one or more alignment criteria are satisfied, processing logic can provide audiovisual embeddings 516 and/or textual embeddings 518 for the media item 121 and the additional media item 121, as well as the value indicated by the outputs of the AI model based on the comparison of the fine-grained embeddings, as an input to trend detection model 184 and/or trend maintenance model 186. Processing logic can determine whether the media item 121 is associated with the media trend based on one or more outputs of the trend detection model 184 and/or trend maintenance model 186, in accordance with previously described embodiments. Responsive to a determination that the one or more alignment criteria are not satisfied, method 700 can proceed to block 412. At block 412, processing logic can determine that the media item is not associated with the media trend. Processing logic can update metadata for the media item 121 (e.g., at media item data store 252) to indicate whether the media item is associated with the media trend, in accordance with previously described embodiments.

At block 414, processing logic, optionally, receives a request for content of the platform from a client device. Media item manager 132 can identify the media item 121 for presentation to a user of the client device 102 in response to the request (e.g., in accordance with a media item selection protocol or algorithm of platform 120). In some embodiments, trend engine 152 (e.g., viewer discovery component 316 of trend discovery module 216) can determine based on data of media item data store 252 whether the media item 121 is associated with a media trend. At block 416, processing logic, optionally, provides the media item to the client device in accordance with the request and an indication that the media item is associated with the media trend for presentation to a user of the client device. Viewer discovery component 316 can provide the notification of whether the media item 121 is associated with the media trend for presentation to the user with the media item 121. In some embodiments, viewer discovery component 316 can additionally or alternatively provide one or more UI elements to client device 102 that enables the user to access other media items 121 associated with the media trend, as described above.

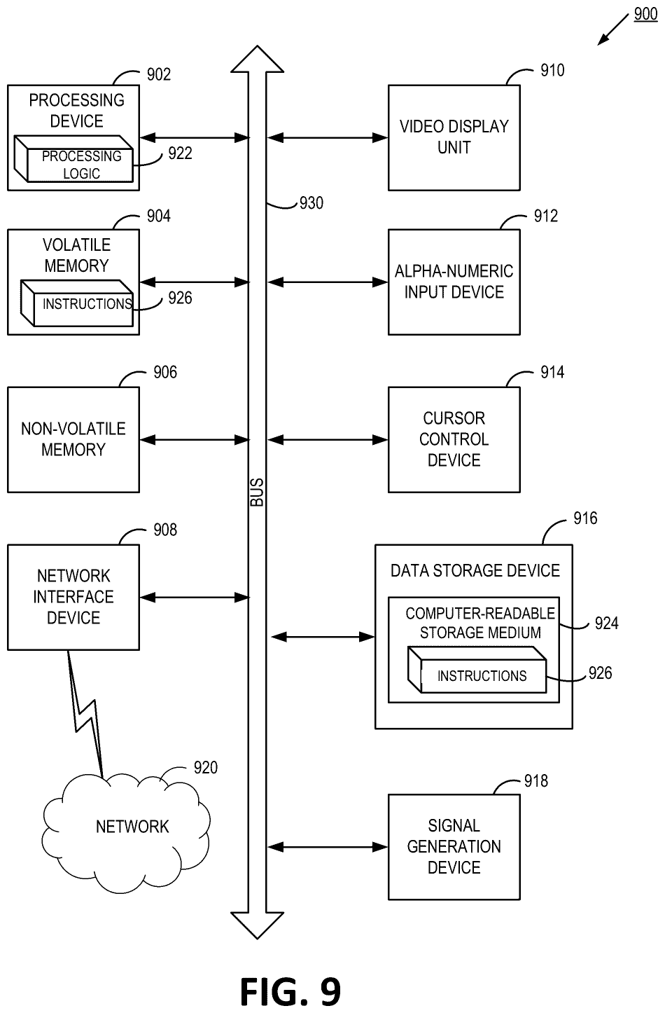

FIG. 9 is a block diagram illustrating an exemplary computer system 900, in accordance with implementations of the present disclosure. The computer system 900 can correspond to platform 120, client devices 102A-N, server machine 130, server machine 150, and/or predictive system 180 described herein and with respect to FIGS. 1-8. Computer system 900 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processing device (processor) 902, a main memory 904 (e.g., read-only memory (ROM), flash memory, dynamic random access memory (DRAM) such as synchronous DRAM (SDRAM), double data rate (DDR SDRAM), or DRAM (RDRAM), etc.), a static memory 906 (e.g., flash memory, static random access memory (SRAM), etc.), and a data storage device 918, which communicate with each other via a bus 940.

Processor (processing device) 902 represents one or more general-purpose processing devices such as a microprocessor, central processing unit, or the like. More particularly, the processor 902 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 902 can also be one or more special-purpose processing devices such as an application specific integrated circuit (ASIC), a field programmable gate array (FPGA), a digital signal processor (DSP), network processor, or the like. The processor 902 is configured to execute instructions 905 for performing the operations discussed herein.

The computer system 900 can further include a network interface device 908. The computer system 900 also can include a video display unit 910 (e.g., a liquid crystal display (LCD) or a cathode ray tube (CRT)), an input device 912 (e.g., a keyboard, and alphanumeric keyboard, a motion sensing input device, touch screen), a cursor control device 914 (e.g., a mouse), and a signal generation device 920 (e.g., a speaker).

The data storage device 918 can include a non-transitory machine-readable storage medium 924 (also computer-readable storage medium) on which is stored one or more sets of instructions 905 embodying any one or more of the methodologies or functions described herein. The instructions can also reside, completely or at least partially, within the main memory 904 and/or within the processor 902 during execution thereof by the computer system 900, the main memory 904 and the processor 902 also constituting machine-readable storage media. The instructions can further be transmitted or received over a network 930 via the network interface device 908.

In one implementation, the instructions 905 include instructions for providing fine-grained version histories of electronic documents at a platform. While the computer-readable storage medium 924 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
identifying a media item comprising a sequence of video frames;
obtaining a set of video embeddings representing visual features of the sequence of video frames;
obtaining a set of audio embeddings representing audio features of the sequence of video frames;
generating a set of audiovisual embeddings based on the set of video embeddings and the set of audio embeddings, wherein each of the set of audiovisual embeddings represents a visual feature and an audio feature of a respective video frame of the sequence of video frames; and
determining one or more media characteristics associated with the media item based on the set of audiovisual embeddings.

2. The method of claim 1, wherein obtaining the set of video embeddings comprises:
providing each of the sequence of video frames as an input to an image encoder; and
obtaining, based on one or more outputs of the image encoder, a sequence of image tokens each representing one or more visual features of a respective video frame of the sequence of video frames,
wherein the set of video embeddings comprises the sequence of image tokens.

3. The method of claim 2, wherein the image encoder comprises a vision transformer.

4. The method of claim 2, wherein the one or more visual features comprise at least one of:
a scene depicted by the sequence of video frames,
an object of the scene depicted by the sequence of video frames,
at least one of an action, a motion, or a pose of the object of the scene,
one or more colors included in the scene, or
one or more lighting features associated with the scene.

5. The method of claim 1, wherein obtaining the set of audio embeddings comprises:
extracting, from the media item, an audio signal associated with a respective video frame of the sequence of video frames;
providing the extracted audio signal as an input to an audio encoder; and
obtaining, based on one or more outputs of the audio encoder, an audio embedding representing audio features of the audio signal.

6. The method of claim 5, wherein the audio encoder comprises an audio spectrogram transformer.

7. The method of claim 5, wherein the audio features comprise at least one of:
a pitch of an audio signal of the media item,
a timbre of the audio signal,
a rhythm of the audio signal,
speech content of the audio signal,
speaker characteristics associated with the audio signal,
environmental sounds associated with a scene of the media item,
spectral features of the audio signal, or
temporal dynamics of the audio signal.

8. The method of claim 1, further comprising:
obtaining a set of textual embeddings representing textual features associated with content of the sequence of video frames,
wherein the one or more media characteristics associated with the media items are further determined based on the set of textual embeddings.

9. The method of claim 8, wherein obtaining the set of textual embeddings comprises:
providing the textual features associated with content of the sequence of video frames as an input to a text encoder; and
obtaining, based on one or more outputs of the text encoder, one or more text tokens representing the textual features,
wherein the set of textual embeddings comprises the one or more text tokens.

10. The method of claim 9, wherein the text encoder comprises a bidirectional encoder representations from transformers (BERT) encoder.

11. The method of claim 1, wherein generating the set of audiovisual embeddings comprises:
performing one or more concatenation operations to concatenate a video embedding of the set of video embeddings with an audio embedding of the set of audio embeddings.

12. The method of claim 11, further comprising:
obtaining an output of the one or more concatenation operations;
performing one or more attention pooling operations to the obtained output of the one or more concatenation operations, wherein the one or more attention pooling operations comprises an audiovisual embedding; and
updating the set of audiovisual embeddings to include the audiovisual embedding.

13. The method of claim 1, wherein the one or more media characteristics comprise at least one of:
whether the media item is associated with a media trend of a platform.
a degree of interest in content of the media item by one or more users of the platform; or
at least one of an image quality or an audio quality of the media item.

14. The method of claim 1, wherein the visual features of the sequence of video frames comprise one or more poses of an object depicted by the sequence of video frames, and wherein determining one or more media characteristics associated with the media item comprises:
identifying a set of embeddings for an additional media item associated with a media trend, wherein the set of embeddings represent visual features of one or more poses of an additional object depicted by an additional sequence of video frames of the additional media item;
determining whether a degree alignment between the one or more poses of the object and the one or more poses of the additional object satisfy one or more alignment criteria based on the set of audiovisual embeddings for the media item and the set of embeddings for the additional media item; and
responsive to determining that the degree of alignment satisfies the one or more alignment criteria, determining that the media item is associated with the media trend.

15. The method of claim 14, further comprising:
providing the set of audiovisual embeddings for the media item and the set of embeddings for the additional media item as an input to one or more comparison operations; and
obtaining, based on one or more outputs of the one or more comparison operations, the degree of alignment between the respective pose of the object and the one or more poses of the additional object,
wherein the degree of alignment represents a difference between the visual features of the one or more embeddings for the media item and the set of embeddings for the additional media item.

16. The method of claim 15, wherein the one or more comparison operations comprise a dynamic time warping function.

17. The method of claim 14, wherein determining whether the degree of alignment satisfies the one or more alignment criteria comprises:
determining whether a difference between the visual features of the set of audiovisual embeddings for the media item and the set of embeddings for the additional media item falls below a difference threshold.

18. A system comprising:
a memory; and
a processing device coupled to the memory, wherein the processing device is to perform operations comprising:
identifying a media item comprising a sequence of video frames;
obtaining a set of video embeddings representing visual features of the sequence of video frames;
obtaining a set of audio embeddings representing audio features of the sequence of video frames;
generating a set of audiovisual embeddings based on the set of video embeddings and the set of audio embeddings, wherein each of the set of audiovisual embeddings represents a visual feature and an audio feature of a respective video frame of the sequence of video frames; and
determining one or more media characteristics associated with the media item based on the set of audiovisual embeddings.

19. The system of claim 18, wherein obtaining the set of video embeddings comprises:
providing each of the sequence of video frames as an input to an image encoder; and
obtaining, based on one or more outputs of the image encoder, a sequence of image tokens each representing one or more visual features of a respective video frame of the sequence of video frames,
wherein the set of video embeddings comprises the sequence of image tokens.

20. A non-transitory machine-readable storage medium comprising instructions that, when executed by a processing device, cause the processing device to perform operations comprising:
identifying a media item comprising a sequence of video frames;
obtaining a set of video embeddings representing visual features of the sequence of video frames;
obtaining a set of audio embeddings representing audio features of the sequence of video frames;
generating a set of audiovisual embeddings based on the set of video embeddings and the set of audio embeddings, wherein each of the set of audiovisual embeddings represents a visual feature and an audio feature of a respective video frame of the sequence of video frames; and
determining one or more media characteristics associated with the media item based on the set of audiovisual embeddings.
